(19) United States
(12) Patent Application Publication
(10) Pub. No.: US 2017/0308896 A1
(43) Pub. Date: Oct. 26, 2017

(54) METHODS AND APPARATUS FOR BROKERING A TRANSACTION

(71) Applicant: Lionel WOLOVITZ, Lymington (GB)

(72) Inventor: Lionel WOLOVITZ, Lymington (GB)

(21) Appl. No.: 15/648,559

(22) Filed: Jul. 13, 2017

Related U.S. Application Data
(63) Continuation of application No. 14/348,368, filed on Mar. 28, 2014.

(30) Foreign Application Priority Data
Sep. 28, 2011 (GB) 1116739.2
Oct. 19, 2011 (GB) 1118040.3

(51) Int. Cl. G06Q 20/38; G06Q 30/06; G06Q 20/40

(52) U.S. Cl. CPC G06Q 20/3829; G06Q 20/405; G06Q 30/06

(57) ABSTRACT

Methods of brokering a transaction between a first party and a second party with a trusted transaction server (TTS) and apparatus therefor. In an aspect, the method includes receiving at the TTS a request for a brokered transaction from the first party over a first communication channel and authenticating the identity of the first party with the TTS. The TTS stores a transaction code with at least some transaction details received from the first party. The TTS receives a message containing the transaction code from the second party over a second communication channel and matches the transaction code with the stored transaction details. The TTS sends a request for authorization for brokering the transaction to the second party. The TTS then authenticates the identity of the second party by way of a secret code and brokers the transaction.

### CROSS REFERENCE TO RELATED APPLICATIONS

This application is continuation of U.S. application Ser. No. 14/348,368, filed Mar. 28, 2014, which is the U.S. National Stage under 35 U.S.C. §371 of International Patent Application No. PCT/GB2012/052337, filed Sep. 21, 2012, and entitled Methods and Apparatus for Brokering a Transaction, which claims the benefit of Great Britain Patent Application No. GB 1118040.3, filed Oct. 19, 2011, and Great Britain Application No. GB 1116739.2, filed Sep. 28, 2011.

### FIELD OF THE INVENTION

The present disclosure relates to methods of brokering a transaction between a first party and a second party with a trusted transaction server (TTS) and apparatus therefor.

### BACKGROUND

It is common in today's information age for two parties to want to carry out a transaction over a computer network involving some exchange of information between the two parties or from one party to a third party. Key technical challenges faced in designing systems for such transactions are keeping the transaction secure, so that the information cannot be stolen or modified by fraudsters for malevolent purposes, whilst making the process convenient for users, and fitting in with existing systems.

One such scenario is a payment transaction, where a party wishes to make a payment to another party by submitting transaction details to a third party, e.g. a payment system. Online commerce has seen rapid global growth over the past decade. This growth and the increasing use of credit and debit cards, both online and in stores, provide an attractive target for fraudsters.

One technique used by fraudsters is keylogging malware, which is a software program that records the keystrokes entered on the PC on which it is installed and transmits a record of those keystrokes to the person controlling the malware over the Internet. Fraudsters can use keylogging to steal the login credentials and security information of financial institution customers. This information can then be used by the fraudster to log into the customer's account and steal funds.

Another technique used by fraudsters is so-called man-in-the middle (MIM) or man-in-the browser (MIB) attacks on their victims. In a MIM/MIB attack, the fraudster inserts himself between the customer and the financial institution and hijacks the online session, allowing the fraudster to intercept the login credentials and security information submitted by the customer and log into the customer's account, or to modify the transaction content or insert additional transactions.

The challenge facing online merchants is balancing ease of use for their customers against security measures that entail entering sensitive information and secret passwords. Online merchants can store customer card details for added user convenience avoiding the re-entry of their details every time they wish to make an online payment. Indeed multiple cards and optionally the customer's delivery address can be stored in an online or digital wallet, for example such as provided by Amazon.com. The merchant typically uses a Payment Service Provider (PSP) to process the card payment, supplying the necessary card details to the PSP who is certified by the card payment schemes. The merchant is responsible for ensuring the secure storage and handling of the customer and card details. Although more convenient than having to enter their card details for every transaction, customers still have to enter further information for each payment, depending on the security measures implemented by the merchant and/or PSP, for example 3-D Secure password, CVV or username and password. Additionally customers have to setup a payment account and enter their card details for each new online merchant.

Despite current security measures, security breaches remain all too common, as demonstrated by some well-publicized breaches of websites belonging to global brands involving the theft of personal and credit card details for tens of millions of customers. Furthermore, users are reluctant to provide their card details to new merchants or brands that are unknown or whose reputation is not well established. It is also expensive and a distraction from their core business for an online merchant to establish a secure digital wallet and payment system. To address these problems a number of payment services have emerged enabling a merchant to receive online payment without having to implement or manage the digital wallet and payment system, for example PayPal, Google Checkout, Amazon Payments and Serve. Although these payment services can be more convenient for customers and merchants, avoiding the need to setup payment accounts or share card details with each merchant, and relieving the merchant of PCI DSS compliance requirements, they have disadvantages for both the customer and merchant. The primary reason for these is that the customer has a relationship with the payment service rather than the online merchant. The merchant receives payment from the payment service rather than an acquiring bank and therefore cannot benefit from a payment-scheme guarantee of payment, and is forced to accept the payment fees charged by the payment service. The customer is not protected by the card scheme's rules and their card statement identifies the payment service rather than the online merchant. Furthermore the customer is still vulnerable to malware and phishing because they have to enter their username and password in the browser, on an inline page on the merchant's website or as a new window provided by the payment service.

With the popularity of mobile devices and the emergence of “smartphones” with sophisticated capabilities, some payment service providers have introduced mobile services enabling customers to make payments directly from their mobile phones in addition to the web based services described above, for example PayPal Mobile and Visa Wallet. Others have introduced mobile only services that include a wallet that is stored on the phone, at the service provider or linked to their bank account, and the phone is then used to authenticate the user or to complete the payment, for example Sprint Mobile Wallet, FNB Cell Pay Point and Mobio. These mobile services either still have the drawbacks of the wallet services described or have other restrictions for example being tied to a single issuing bank or card type, do not support card authentication schemes (for example 3-D Secure) and therefore merchants cannot benefit from the protection and lower transaction fees that are otherwise available or are limited to mobile commerce conducted on the phone.

A further alternative for mobile payment is Near Field Communications (NFC) enabled phones that incorporate a radio frequency ID (RFID) and smartcard chip that allow customers to pay at NFC enabled merchant terminals instead of using physical payment cards. The NFC enabled phone is combined with a payment application and wallet service, such as Google Wallet or Visa Wallet, which means the customer does not need to carry physical payment cards, which eliminates the risk of loss or theft of the cards as well as reducing the risks from card skimming at ATM or payment terminals. The disadvantages of NFC payment are the significant expense for merchants to upgrade their POS systems to support NFC and the need for customers to acquire new mobile phones that incorporate NFC. Additionally if the customer's phone is lost or stolen they have to report the loss to their issuing banks, cancel their cards and then re-provision the cards when the phone is replaced, a process even more inconvenient than the loss of physical cards. Furthermore NFC does not facilitate using the phone or wallet for online payments.

Other scenarios where users commonly wish to transact relate to online services and authentication. The growth and ease of access to the Internet has led to the proliferation and popularity of a wide-range of online services for example email, news (press), entertainment (music, TV, film), search, online banking and financial services, health-care, government and social networking. Many of these services require the user to create an online account before they can use the service and the user then has to login to their account to gain full access to the content and/or services. The login usually takes the form of a user identifier or username and a secret password. Remembering and managing the ever-growing number of usernames and passwords is a well-documented challenge for users. This proliferation of passwords encourages the poor security practice of using easy to remember passwords or even worse reusing the same password for multiple online services.

Various solutions have been developed to aid users in managing and using their online credentials. The most common is a password manager built into a web-browser that can automatically enter the password on behalf of the user (form filler). Although this is a convenient solution when using the browser on the computer where the passwords are stored, the user cannot access or use the stored passwords when using a different computer or indeed an alternative web browser on the same computer. Additionally these solutions pose a security risk in that an attacker can use the solution to access the online accounts of the user or even extract the passwords from the browser. Alternative password manager applications that can work with multiple browsers are available, for example Lastpass, Password Safe, or services to manage passwords across applications, for example the Keychain in MacOS from Apple Inc. These solutions similarly have the drawback that they are only available on the computer where the passwords are securely stored.

Furthermore the process of authentication to these services is vulnerable to MIM/MIB attacks and keyloggers, allowing attackers to steal credentials or gain access to the user's account. Many solutions have been proposed and are available to improve authentication security, the most notable being one-time passwords (OTP) using tokens (for example RSA SecurID, CRYPTOCARD Blackshield) or delivered “Out-of-band”, for example by SMS (for example Google 2-step verification, Facebook One-time password). A mobile phone based variant is available from Accumulate. Out-of-band authentication means that a transaction that is initiated via one delivery channel (e.g., Internet) must be re-authenticated or verified via another delivery channel (e.g., telephone or SMS) in order for the transaction to be completed. The solutions incur extra cost and do not lend themselves to universal adoption. Furthermore these solutions remain vulnerable where the out-of-band authentication is directed to or input through the same device that initiates the transaction, since that device may have been compromised.

Furthermore, signing up to new online services is tedious as users typically have to provide their email address, that they may then have to verify, prove that they are human by completing a “CAPTCHA”, and then provide personal details and create yet another password. Many of these services do not actually need user details and could support anonymous registration. Such services have been developed, the most notable being OpenID and InfoCard. However adoption of these services has been slow. Concerns remain that the single sign-on is vulnerable to phishing attacks and that a compromised account can result in breaches to all services using this account. Furthermore, users have privacy concerns about sharing of personally identifiable information and tracking of browsing habits.

It is an object of the present disclosure to provide an improved secure payment, authentication and verified wallet method with comprehensive user privacy control.

### SUMMARY OF INVENTION

According to a first aspect of the present disclosure, there is provided a method of brokering a transaction between a first party and a second party with a trusted transaction server (TTS), the method comprising: receiving at the TTS a request for a brokered transaction from the first party, the request being sent over a first communication channel from a first application running on a computing device, the request comprising at least some transaction details; authenticating the identity of the first party with the TTS; generating a transaction code for the transaction; storing the transaction code with at least some transaction details received from the first party at the TTS; receiving at the TTS a message from the second party, the message being sent over a second communication channel from a second application running on a computing device, the message containing the transaction code, matching the transaction code received from the second party with the transaction details for that transaction code stored at the TTS, sending a request for authorisation for brokering the transaction from the TTS to the second party including at least some of the details of the transaction for display to the second party, the TTS authenticating the identity of the second party by way of a secret code received from the second application and receiving authorization by the second party for brokering the transaction, with the TTS, brokering the transaction with the first party and/or a third party including sending information necessary for authorisation of the transaction to the first party and/or third party.

The disclosure allows transactions to be brokered between a first party and a second party by the TTS. The transaction being brokered can be in principle any type of transaction, as the examples will make clear. The first party authenticates with the TTS, so the TTS knows the identity of that party. The second party also authenticates with the TTS as well as authorising the brokering of the transaction. Thus, a trust relationship is developed by both parties to the TTS and therefore both parties trust the TTS to broker the transaction. The disclosure is particularly useful where there is no trusted communication channel directly between the first party and second party. For example, where the first party and second party are communicating via the Internet, it is well know that malware can affect security of communications between the parties. By brokering the transaction via the TTS, the first and second parties avoid having to supply sensitive information to each other via the non-secure channel.

Brokering in this context means requesting the transaction and supplying necessary information for the transaction to whatever entity is responsible for approving the transaction. Brokering does not necessarily imply that any commission is taken by the TTS, although this is possible. The brokering can be with a third party, for example where the transaction is a payment. In this type of case, whether or not the transaction is approved may not be up to any of the parties or the TTS, but will instead by decided by the third party. Alternatively, the brokering can be with the first party, for example secure login to an online service provided by the first party, in which case the first party will decide whether or not to approve the transaction depending on the information received from the TTS. The TTS is preferably independent of the other parties to the transaction.

The transaction code is used to identify the transaction at the TTS, i.e. to relate the transaction data received from the various parties to the same transaction. An important advantage of this method is the transaction code does not necessarily have to be kept secure. For example, in a payment transaction, if a malicious other party managed to obtain the transaction code and tried to use it, then they could not authorise the transaction instead of the second party, since they would not be able to authenticate themselves to the TTS as the second party. If they authorised the transaction using their own identity, then this would result in the other party paying for the transaction for the second party. Thus, the method is robust against fraud and malicious activity.

Authentication by supplying the secret code can implicitly authorise brokering a transaction, or second party can separately authorise brokering in a separate, later step. Authentication can take place once and then persist for a predetermined amount of time, say 30 minutes, during which time the second party can authorise transactions without having to authenticate again

The secret code can be entered by second party, or can be derived automatically from a hardware identifier associated with the second computing device, a SIM, another secret provided by second party, a biometric scan, etc.

According to a second aspect of the present disclosure, there is provided a method of brokering a transaction between a first party and a second party with a trusted transaction server (TTS), the method comprising: generating a transaction code for a transaction, the transaction code containing information identifying the first party and the transaction; receiving at the TTS a request for a brokered transaction from the second party including the transaction code, the request being sent over a second communication channel from a second application running on a computing device, matching the first party with first party details stored at the TTS using the information identifying the first party contained in the transaction code, the details including details of communications with the first party, authenticating the first party and establishing a first communications channel between the TTS and the first party based on the details, sending the transaction code from the TTS to the first party over the first communication channel and receiving at the TTS from the first party at least some transaction details over the first communications channel; storing the transaction code received from the second party with at least some details of the transaction received from the first party at the TTS; sending a request for authorisation for the brokering of the transaction from the TTS to the second party including at least some of the details of the transaction for display to the second party, the TTS authenticating the identity of the second party by way of a secret code received from the second application and receiving authorization by the second party for brokering the transaction, with the TTS, brokering the transaction with the first party and/or a third party including sending information necessary for authorisation of the transaction to the first party and/or third party.

Preferably the method comprises creating a profile for the second party including information associated with the second party, wherein the TTS accesses the profile and supplies some or all of the information to the first party and/or third party when brokering the transaction.

This provides convenience for the second party by storing information that is required for a transaction in a profile, avoiding the need for the second party to manually supply this information for each transaction. The profile can in principle be stored anywhere where it is accessible by the TTS, for example at the TTS itself. Preferably, the profile is held securely, which helps reduce the risk of sensitive information being stolen or tampered with. The second application can send a second party identification code to the TTS for accessing the appropriate second party's profile. This can be useful to identify the second party where more than one second party uses the same computing device to communicate with the TTS.

Preferably the profile comprises reserved information which can be accessed by the TTS only once the second party has authenticated, and unreserved information which can be accessed without the second party having authenticated. This improves the security of the information by arranging that sensitive information can only be accessed by the TTS once the second party has authenticated themselves. Nonetheless, flexibility can be provided by having unreserved information that can be accessed without authentication for less sensitive information.

Preferably the reserved information consists of a wallet comprising one or more of: information relating to the second party, optionally including one or more of the party's title, name, surname, date of birth, postal address, email address, telephone number, gender, marital status; details of financial instruments held by the second party, such as card numbers, start dates, expiry dates, bank accounts, bank sort code, bank details and associated information needed to use the financial instrument, such as passwords, 3-D Secure information, CVV codes; details of security information required to use the TTS such as one or more of passwords; details of loyalty or rewards accounts optionally including account numbers, card numbers and scheme name or identifier; and, details of online service accounts including an account identifier and optionally a password.

Preferably, the reserved information includes the geo-location of the second computing device. For example, this could be the GPS location of the mobile phone derived from the phone operating system, or some other known location technique. This information can be used in combating fraud.

Preferably said reserved information can be made available by the TTS or used in a transaction only when the brokering of the transaction has been authorised by the second party.

In an embodiment, the reserved information is stored in encrypted form and is encrypted and decrypted at the TTS using the secret code or a key derived from at least the one or more secret codes.

In a preferred embodiment, the key is derived from a first random salt stored in the second party profile and two or more secrets; the key being cryptographically split with the first part being stored in the second party profile and the second part derived from a second random salt stored in the second party computing device and one secret.

This adds further security to the information held by meaning that it is impossible to access the information at the TTS without the one or more secret codes.

In an embodiment, the method comprises: creating at the TTS a profile for the first party holding at least one piece of information that is used for some or all transactions involving that party; and, the TTS accessing the information based on the identity of the first party and using said at least one piece of information for brokering the transaction. This provides convenience for the first party by holding information required for a transaction at the TTS, so that the first party does not have to supply this information for each transaction. The identity of the first party can be established by sending a first party ID code from first application to TTS which accesses the appropriate profile.

In an embodiment, the method comprises specifying the transaction details as mandatory data items and optional data items, wherein when authorising the transaction with the second application the second party chooses whether or not to include the optional data items in the transaction. Whether or not a parameter is mandatory or optional can be specified by the first party, or can be set according to the transaction type. This provides flexibility for transactions. For example, in a secure signup scenario, where the second party wants to sign up to an online service provided by the first party, the first party can specify that some information, such as name and address, is mandatory, whilst other information, such as geo-location or date of birth, is not mandatory and can be supplied or not according to wishes of the second party. The data items can be specified by the first party, specified by the second party or taken by the TTS from the profile associated with the first party or second party.

Preferably at least one transaction detail can be specified by the second party, the specified data item being sent to the TTS when authorising the brokering of the transaction, and used by the TTS when brokering the transaction. The second party can for example edit a default value, enter value into a blank field, and/or select from options presented to the second party, for example, suitable items from the wallet. The second party can thus supply information to be used in the transaction.

Preferably the second party's wallet contains details of plural items of information in a particular class of items that can be used in the transaction, wherein the unreserved information of the second party's profile contains a list of names identifying said plural items held in the wallet, the method comprising: the TTS accessing the list and presenting some or all of the names to the second party for selection when authorising the transaction; and, the TTS receiving the selection from the second party when authorising the transaction and accessing the corresponding details for the selection in the wallet and the TTS using the details for brokering the transaction.

For example, in a payment scenario, the reserved information can comprise details of different financial instruments or loyalty schemes held by the second party, e.g. credit card details needed for a payment, whereas the unreserved information can hold non sensitive information about the financial instruments which allows the financial instruments to be identified by the second party. The non sensitive information can be supplied to the second party to allow the second party to select the financial instrument to use in a transaction and this information returned to the TTS. The TTS can then access the appropriate sensitive information for the financial instrument in the reserved part of the profile once the second party has authenticated and provide this information when brokering the transaction. Thus, the sensitive information does not have to be sent to the second party for each payment transaction, which can improve security.

In an embodiment, the method comprises the first party creating at least one rule restricting how at least one transaction detail may be specified by the second party, the TTS or first application applying the rule to the transaction details to display to the second party only transaction details that are selected by the rule.

Again referring by way of example to the payment scenario, a rule can be created to specify acceptable methods of payment, e.g. only Visa credit cards are accepted or PayPal is not accepted. The TTS then only displays to the second party credit cards held by the second party that are part of the Visa network. This prevents options for a transaction being presented to and chosen by the second party that are not acceptable to the first party. Rules can be created in principle for any aspect of the transaction. For example, a minimum tip value can be specified, e.g. no less than 10%, etc.

Preferably the first and second communication channels are separate. For example, one channel may be a mobile phone network channel, whereas the other channel is not a mobile phone network channel, e.g. an internet channel. By keeping the channels separate, i.e. preferably there is no common link or node in the channel, the system is immune to the type of “man in browser” attacks prior art systems suffer from. This also improves immunity to man in the middle attacks, key-loggers, and other malware. Preferably the first and the second communication channels use encryption.

In an embodiment, the method comprises communicating the transaction code from the first party to the second party optionally over a non secure channel. Because the transaction code need not contain any information relating to details of the transaction, the transaction code can be communicated on a non-encrypted channel, in plain text, and even advertised without risk of fraud. If for example in a payment transaction a fraudster intercepted the transaction code intended for the second party and the fraudster used it themselves, this would only enable them to pay for the second party's transaction for them. Thus, the transaction code can be safely transmitted over a non secure channel.

In an embodiment, the transaction code is generated such that it is unique for a predetermined length of time, unique for the first party, and/or unique for the TTS, or any combinations thereof.

In a preferred embodiment, the computing device that runs the second application is a mobile device. This is a particularly preferred embodiment, since it allows the second user to complete a transaction practically anywhere without being tied to a particular geographical location.

In an embodiment, the mobile device also runs the first application. This is useful for an “in app” purchase, where the first party provides an application that is run by the second party on the second party's mobile device and can elect to make a transaction via the TTS, e.g. pay or sign in.

In an embodiment, the first application is a back-end application running on a back-end computing device which is arranged to communicate with one or more front-end applications running on other computing devices by which the second party interacts with first party to initiate the transaction and by which the first party communicates the transaction code to the second party. This is particularly useful in many scenarios where the first party has a distributed computer system. The application can be for example client and server, web browser application and web server, merchant backend system and Point of Sale terminal, ATM network and ATMs, etc. In some cases, there will be plural customer-facing front end computing devices by which the second party and the first party agree on a transaction, e.g. a Point of Sale terminal in a chain of shops where the second party wishes to pay for goods, and a back-end system which is linked to all of the Point of Sale terminals and which arranged payment. The backend system could consist of one or more servers, be hosted by the merchant or outsourced, use cloud computing or combination thereof.

In an embodiment, the transaction details sent from the back-end application to the TTS includes information relating to the computing device running the front-end application or the session of the front-end application by which the second party initiated the transaction with the first party, the method comprising the TTS sending these details to the back-end application with confirmation that the transaction has been successful or not, the back-end application using these details to send the confirmation to the appropriate front-end computing device and/or session. This allows the information that the transaction has been successful to be propagated back to the customer-facing computing device where the first and second parties initiated the transaction so that the appropriate action can be taken. For example, in the above-mentioned Point of Sale example, the salesperson is informed that the payment has been successful so they can hand over the goods to the second party.

In an embodiment, the second party comprises a beneficiary and an authoriser, wherein the beneficiary interacts with the first party to request the brokered transaction from the TTS and receives a transaction code, the beneficiary communicates the transaction code to the authoriser and the authoriser authorises the transaction using the transaction code. This is useful for example where one party wishes to pay for something on behalf of another party.

In a preferred embodiment, the method comprises communicating the transaction code from the first party to the second party, the step of communicating the transaction code to the second party comprises generating a machine readable code for the transaction code, the first party communicating the machine readable code to the second party in a visible form, and the second party scanning the machine readable code with the second computing device. This provides a simple and convenient way of entering the transaction code into the second application. This is particularly preferred where the second application is running on a mobile device. For example, the second party when making a payment can be presented with a machine readable code printed out on an invoice or displayed at the POS, and which can be scanned by the mobile device to enter the transaction code.

In embodiments, the method comprises communicating the transaction code from the first party to the second party, the step of communicating the transaction code to the second party comprises the first party communicating the transaction code to the second application electronically via a wireless network, such as Near Field Communications (NFC), Bluetooth, or Simple Messaging Service (SMS).

In an alternative embodiment, the method comprises communicating the transaction code from the first party to the second party, the step of communicating the transaction code to the second party comprises communicating the transaction code to the second party and the second party typing the transaction code into the computing device running the second application.

In an embodiment, the method comprises communicating the transaction code from the first party to the second party, the step of communicating the transaction code comprises the second application receiving the transaction code from the first application in electronic form, which can be over a computer network where the applications are running on different computing devices, or directly where the applications are running on the same computing device.

In a preferred embodiment, as well as identifying the transaction, the transaction code decodes as a website identifier which can be used to take the second party to a website associated with the first party. If the second party chooses not to make the transaction using the TTS, the second party can be taken to the website to make the transaction using some other means. For example, for a payment transaction, if the second party does not wish to pay using the TTS, the transaction code can be used to take the second party to the merchant's website where he can pay using conventional means. Thus, the transaction code advantageously has a double use.

In an embodiment, the transaction code includes a TTS identifier for identifying the TTS that is to broker the transaction, the method comprising the second application using the TTS identifier to access a lookup table to find the TTS contact details for the TTS; and, the second application using said TTS contact details to communicate with the TTS. The TTS identifier and related contact details are preferably stored in local storage by the second application during a customer registration process when the second party registers with a TTS. Alternatively, the lookup table could be stored centrally at a server with which the second computing device communicates to access the lookup table. The contact details for the TTS may be for example a URL allowing the TTS to be contacted or some other identifier. This embodiment allows multiple TTS to be used. This also allows private TTS to be used in addition to public TTS. The second application may also store a user profile for the second party which stores TTS identifiers for the TTS available to the second party. This allows multiple users of the second application/second computing device to each have their own associated TTS. As will be appreciated, the concept of having multiple TTS can be applied to any of the embodiments described herein.

The transaction code may be generated by: generating the transaction code at the TTS and communicating it to the first party over the first communication channel, or generating the transaction code at the first party computing device and communicating it to the TTS over the first communication channel.

The first and/or second communication channels may be provided by one or any combination of IP, over Internet, wide-area wireless (GSM, UMTS, CDMA), WiFi, SMS or USSD.

Preferably authentication comprises at least one additional factor which is verified by the TTS, including one or any combination of: the mobile device identity; the answer to a security question; and, a password or phrase. The mobile device identity can be verified on basis of the mobile device phone number, SIM settings, and/or security certificates/tokens.

Preferably the additional information is sent to the TTS in the form of a cryptographic hash.

In an embodiment, the method comprises creating a duress code for the second party, and the TTS raising an alarm if the duress code is entered by the second party and optionally obtaining GPS information of the second party's mobile device to locate the second party.

In an embodiment, the method comprises receiving transaction authorization from the second party and sending a confirmation message to the second party, the confirmation message comprising one or more of: details of the transaction, details of the first party, time and date of the transaction, location where transaction was authorized, what information was shared with first party. This method could be used for example to provide a receipt for an online purchase. The method could also be used for example to confirm a transaction for online banking or login to a website. The confirmation email provides an audit trail for the second party as well as a means of potentially detecting fraudulent activity.

In an embodiment, the transaction is a payment from the second party, the payee, to the first party, the merchant, wherein the transaction information provided by the merchant to the TTS includes a merchant identifier, a transaction identifier and a transaction amount, and wherein the second party's profile comprises a wallet for the payee comprising details of at least one financial instrument by which payment can be made, and wherein a merchant profile comprising details of at least one bank account associated with the merchant is stored at the TTS, the TTS communicating with a third party arranged to make the payment and supplying to the third party information including at least details of a financial instrument from the wallet, the merchant bank account from the merchant profile and the transaction amount.

In an embodiment, the wallet includes details of plural financial instruments, the method comprising the step of the TTS receiving from the payee a selection of which financial instrument is to be used for the payment.

In an embodiment, the method comprises receiving confirmation at the TTS from the third party that payment has been successful or not and sending a message to the merchant and or the payee that the payment has been successful or not.

In an embodiment, the message is sent to the payee in an email and or SMS message to an email address and or mobile number stored in the wallet.

In an embodiment, the wallet holds a delivery address for the payee, optionally including a postal address and or an email address, which is sent to the merchant with confirmation that the payment has been successful to allow goods and or documentation of the transaction to be sent by the merchant to the payee.

In an embodiment, the TTS stores a merchant profile for the merchant including details of at least one PSP to allow the TTS to communicate with the PSP to arrange the payment.

Preferably, the TTS is arranged to be able to communicate with plural different PSPs and provides the information in an appropriate format for the PSP for the merchant for the particular transaction.

In an embodiment, the TTS incorporates a PSP and communicates directly with acquiring bank/payment network.

In a preferred embodiment, the wallet holds additional security information for the payee associated with a financial instrument, the method comprising: as part of authorising the transaction, sending the additional security information from the TTS to an authorising server to obtain an authorisation code for the transaction; and, providing the authorisation code to the third party. This can be used to supply for example 3-D Secure information to the issuing bank to “prove” to the issuing bank that the person using the financial instrument is the holder. This can result in lower transaction charges.

In an embodiment, the payee redeems an offer when paying, the method comprising: the TTS receiving details of the offer; when the transaction has been authorised, the TTS sending at least some details of the offer together with an anonymous, unique code associated with the payee to a fourth party for tracking take-up of the offer and/or activity of the payee.

In an embodiment, an offer identifier representing an offer previously made by the merchant is stored by the payee in their profile, the method comprising: wherein the transaction details sent from the first party to the TTS include an identifier for the merchant; when the transaction code is received by the TTS from payee and matched to the stored transaction details, searching the payee's profile for the merchant identifier and finding the offer identifier; sending the offer identifier to the merchant; the merchant checking the validity of the offer identifier, recalculating the payment amount in line with the details of the offer and sending the revised transaction details to the TTS, for display to the payee; when authorisation for brokering the transaction is received from the payee, the TTS brokering the payment and sending at least some details of the offer together with an anonymous, unique code associated with the payee to a fourth party for tracking take-up of the offer and/or activity of the payee.

Alternatively, the offer can be handed to the salesperson by the payee when paying, and the salesperson can enter the offer details into the merchant's payment system to re-calculate the payment amount before sending this to the TTS.

In an embodiment, the transaction is a pre-payment authorisation from the second party, the payee, to the first party, the merchant, wherein the transaction information provided by the merchant to the TTS includes a merchant identifier, a transaction identifier and a pre-payment amount, and wherein the profile information stored at the TTS comprises a wallet for the payee comprising details of at least one financial instrument by which payment can be made, and a merchant profile comprising details of at least one bank account associated with the merchant, the TTS communicating with a third party arranged to request a prepayment authorisation and supplying to the third party information including at least details of a financial instrument from the wallet, the merchant bank account from the merchant profile and the pre-payment amount.

The merchant can then send a message to TTS to cancel the pre-payment authorisation if the payee chooses to settle their bill, i.e. via a TTS payment or via a conventional payment. Alternatively, if the payee chooses not to or forgets to settle their bill, the merchant can send a message to TTS to broker a payment for the amount of the bill.

The computing device running the first application may be a merchant server running an online shopping application by which a payee selects goods and/or services and chooses to pay via the TTS. The computing device running the first application may be part of a merchant sales system linked to one or more Point of Sale terminals or handheld devices where a payee selects to pay via the TTS.

The first application may be running on a vending machine or a back end system which communicates with a vending machine, through which vending machine the second party selects goods and/or services, the vending machine being arranged to release the goods and/or services to the second party once confirmation that the payment transaction has been approved has been received from the TTS.

The first application may be running on a mobile device associated with the first party. This is useful for “mobile merchants” who want to be able to receive payment via for example credit cards without having to invest in a conventional payment system.

In an embodiment, the payee specifies a tip when authorising a payment transaction, the altered payment amount being communicated from the second application to the TTS and used by the TTS to broker the payment with the third party.

In an embodiment, the transaction code can be used by the same first party for more than one transaction from the second party or different second parties.

In another embodiment, the transaction is a donation or gift from the second party, the payee, to the first party, the recipient, wherein the transaction information provided by the recipient to the TTS includes an account identifier and a transaction code, wherein the payee can enter the payment amount when authorising a transaction, the payment amount being communicated from the second application to the TTS and being used by the TTS to broker the payment with the third party.

In yet another embodiment, the transaction type is the second party signing-in to an account for an online service associated with the first party, the profile for the second party including a record containing an identifier for the online service and an identifier which identifies the second party's account to the online service, the method comprising: wherein the transaction details sent from the first party to the TTS include an identifier for the online service, this being sent to the second party for display; when authorisation for brokering the transaction is received from the second party, the TTS finding the identifier for the account for the second party and for that online service from the second party's profile; and, sending the account identifier and confirmation that second party has been authenticated so that the user can be signed-in to the online service by the online service. For example, the record could contain “89736485261” as the identifier for “Amazon”® together with the second party's userid for logging into the amazon website. This allows a secure way for the second user to sign in to an online service. Confirmation that second party has been authenticated can be sent implicitly by just sending the account identifier, on the basis that the identifier would not be sent if the second party did not authenticate and authorise the transaction. The online service can be for example a website or a mobile application.

In an embodiment, the TTS participates in a challenge-response authentication protocol with the first party using at least one secret from the account identifier to broker the authentication of the second party with the first party. This could be used to provide a legacy password, or a more secure and sophisticated method, for example Secure Remote Password protocol (SRP).

Alternatively, the transaction type is the second party signing-in to an account for an online service associated with the first party, the profile for the second party including one or more records containing information which identifies the second party's account to the online service, the method comprising: wherein the transaction details sent from the first party to the TTS include a request for the identifying records, this being sent to the second party for display; when authorization for brokering the transaction is received from the second party, the TTS finding the identifying records from the second party's profile; and, sending said records and confirmation that the second party has been authenticated so that the second party can be signed-in to the online service by the online service. This scheme can be used for example where an email address or other unique user identifier is used as a unique account identifier for the online service. In other words this scenario does not rely on using an identifier specific to the online service and an account identifier as in the embodiment described above. The first party, i.e. the merchant in a payment scenario, would simply request information from the wallet that they can use to uniquely identify the user, e.g. the email address. Thus, the user can login to an existing account without having to previously go through a signup step. This is less secure than signing up, but may be preferable for situations where usability and convenience are of more importance that security.

In an embodiment, the TTS can also store a password for the online service account. Preferably, a password is not needed. The online service just requires the TTS to return the account identifier and confirmation that the second party has been authenticated to approve sign-in. However, some legacy systems may still require a password to be provided. In this case, the TTS can supply the password with the account identifier.

In a further embodiment, the transaction type is the second party signing-up to an account for an online service associated with the first party, the method comprising: wherein the transaction details sent from the first party to the TTS include a list of one or more user information fields requested for creating the account, for being sent to the second party for display; when authorisation for brokering the transaction is received from the second party, the TTS finding the user information for the requested fields from the second party's profile and sending the information for the requested fields to the online service; the online service creating an account and an account identifier for that account and sending the account identifier to the TTS; and, the TTS storing the account identifier associated with the online service identifier in the second party's profile. This allows the second party to securely sign up to an online service. This embodiment can be used with the techniques of specifying mandatory/optional information described above.

In a further embodiment, the transaction type is the second party registering with an existing account for an online service associated with the first party when signed-in to said account, the method comprising: wherein the transaction details sent from the first party optionally include a list of one or more user information fields requested for verifying the account, for being sent to the second party for display; when authorization for brokering the transaction is received from the second party, the TTS finding the user information for the requested fields from the second party's profile and sending the information for the requested fields to the online service; the online service verifying the requested fields; the online service optionally authenticating the second party using means configured for that online account; the online service sending the account identifier for the account to the TTS; and, the TTS storing the account identifier associated with the online service identifier in the second party's profile. The second party is already logged in to their account, and thus they have already authenticated using the existing mechanism. The method can be used to “bind” an existing account to the TTS system.

Preferably the account identifier consists of one or more of: a unique account code; a password; a cryptographic token; and, a cryptographic key for the production of digital signatures.

In a yet further embodiment, the transaction is a withdrawal of money by a card holder, the second party, from a card issuer, the first party, via an automated teller machine (ATM), the method comprising: the card holder or a beneficiary requesting a withdrawal transaction at an ATM, the card holder or beneficiary optionally providing the transaction amount via the ATM; the ATM communicating with the ATM network and requesting a transaction code from the TTS and sending the ATM identifier and the transaction amount where provided via the ATM to the TTS with; the ATM displaying the transaction code to the card holder or beneficiary, where the beneficiary is not the card holder, the beneficiary communicating the transaction code to the card holder; the card holder communicating the transaction code to the second application on the second computing device, entering the transaction amount via the second application if not already provided, and authorising the transaction; and, the TTS arranging the withdrawal with the card issuer and receiving a message that the withdrawal is approved or not, if the withdrawal is approved, the TTS sends a communication to the ATM network using the ATM identifier to prompt the ATM to issue the requested amount of money.

In an embodiment, the transaction is an authorization of an action requested by the second party on an online service associated with the first party, the method comprising: wherein the transaction details sent from the first party to the TTS include an identifier for the online service and details for the action being taken, this being sent to the second party for display; when authorization for brokering the transaction is received from the second party, the TTS sending the authorization for the action being taken to the online service so that the online service can allow the action to be taken.

In an embodiment, the second party profile includes a record containing an identifier for the online service and an identifier which identifies the user's account to the online service, the method comprising: wherein the transaction details sent from the first party to the TTS include an identifier for the online account, an identifier for the online service and details for the action being taken, this being sent to the second party for display; when authorization for brokering the transaction is received from the second party, the TTS finding the identifier for the online account for the second party and for that online service from the second party's profile; the TTS checking the account identifier matches that sent by the online service; and, sending the authorization for the action being taken to the online service so that the online service can allow the action to be taken.

In an embodiment the second party profile includes a record containing an identifier for the online service and an identifier which identifies the user's account to the online service, the method comprising: wherein the transaction details sent from the first party to the TTS include an identifier for the online account, an identifier for the online service and details for the action being taken, this being sent to the second party for display; when authorization for brokering the transaction is received from the second party, the TTS finding the identifier for the online service and the associated account identifiers for the second party from the second party's profile; sending the account identifiers and authorization for the action being taken to the online service; the online service checking the account identifier matches that sent by the TTS; and, the online service proceeding to allow the action to be taken.

In an embodiment, the second party profile includes a record containing an identifier for the online service, an identifier which identifies the user's account to the online service and a cryptographic key associated with said online account, the method comprising: the TTS finding the cryptographic key associated with the online account and digitally signing details of the action to be taken; sending the digitally signed details to the online service so that the online service can allow the action to be taken.

Preferably a second secret code is used for adding strong authentication, as described above.

In an embodiment, the transaction is an anonymous subscription by the second party to an online service associated with the first party, the second party's profile including a record containing an identifier for the online service and a token, the token representing an anonymous subscription to the online service previously issued by the first party and stored in the second party's profile, the method comprising: wherein the transaction details sent from the first party to the TTS include an identifier for the online service; when the transaction code is received by the TTS from the second party and matched to the stored transaction details, searching the second party's profile for the online service identifier and finding the token; sending the token to the online service; the online service checking the validity of the token and optionally sending further transaction details to the TTS, for display to the second party; when authorisation for brokering the transaction is received from the second party, the TTS sending authentication confirmation for the second party to the online service so that the online service can grant anonymous access to the second party. Thus, the second party can be subscribed anonymously to the service without the first party needing to be supplied with any information about the identity of the second party. The token identifies the second party's subscription to the online service.

In an embodiment, if the online service determines that the token is invalid, the online service initiates a payment transaction with the second party, and when the TTS has brokered the payment transaction and received confirmation that the payment has been authorised, the TTS sends payment confirmation to the online service so that the online service can issue a new token, which is sent to the TTS and stored in the second party's profile, and grant anonymous access to the second party. If the token has expired for example, the transaction can be converted into a payment transaction as described above, by which the second party can purchase a new subscription and receive a new token.

In an embodiment, the transaction is enrolment by the second party of a financial instrument provided by the first party, the method comprising: the second party providing details of the financial instrument and optionally additional security information related to said financial instrument to the TTS; the TTS verifying the details of the financial instrument with a third party; the TTS verifying the security information with one or more of the first party, the third party or a fourth party; the TTS storing details of the financial instrument and security information in the second party's profile. The fourth party in this scenario could be for example 3-D Secure which can be used to verify ownership of a credit/debit card thus leveraging the proof of ownership established by the card issuer. Alternatively, various online banks issue card readers to card holders which are used to verify a user is in possession of a card when making an online transaction. Thus, the first party can be prompted by the TTS to use the card reader to verify that they are in possession of the card at the time of enrolment. Similarly, the verification of the card being present at the time of enrolment can be conducted by enrolling the card via an ATM machine which reads the card. By verifying that the financial instrument is in the possession of the second party at the time of enrolment, subsequent transactions with the financial instrument via the TTS system can be considered as “card present” transactions rather than “card not present” transactions, which has the advantage that lower percentage charges may apply for the merchant.

In an embodiment, the transaction is enrolment of a financial instrument by the second party when signed-in to an online bank service held with the first party, the first party providing the financial instrument, the method comprising: the second party indicating to the online bank service that they wish to enroll a financial instrument with TTS, the online bank service obtaining a transaction code from the TTS and communicating the transaction code to the first party via the webpage; the second party authenticating to the TTS and authorising brokering of the enrolment by the TTS; the online bank service optionally verifying the ownership of the financial instrument by the second party using means configured for that financial instrument; the online bank service sending details of the financial instrument to the TTS to be stored in the second party's profile.

In an embodiment, the transaction is the second party validating information in the second party's profile with a validation service, the first party, the method comprising: the validation service requesting a transaction from the TTS and sending details of the information fields to be validated with the transaction details, the validation service communicating the transaction code to the first party; the TTS sending the information from the second party's profile to the validation service; the validation service validating the information; and, the validation service generating a validity certificate for the information and sending it to the TTS, which stores the validity certificate in the second party's profile.

In an embodiment, at least one item of information in the second party's profile can be marked as validated, the method comprising: the first party specifying when sending transaction details to the TTS that at least one item of information from the second party's profile for the transaction needs to be validated information; and, when the second party authorises the transaction, the TTS checking that the at least one item is validated and sending confirmation to the first party and optionally sending a validity certificate containing a cryptographic hash of the validated information to the first party.

In an embodiment, at least one item of information in the second party's profile can be marked as validated, the method comprising when the second party authorises the transaction, the TTS finding from the second party's profile that at least one item of information to be used in the transaction has been validated or not and sending to the first party confirmation that the item has been validated or not and, if validated, optionally sending a validity certificate containing a cryptographic hash of the validated information to the first party.

In an embodiment, the second application runs in a secure environment on the second computing device.

According to a third aspect of the present disclosure, there is provided a Trusted Transaction Server (TTS) for brokering a transaction between a first party and a second party, the TTS being constructed and arranged to carry out any of the methods as described above.

According to a fourth aspect of the present disclosure, there is provided a computer program, optionally recorded on a carrier, containing program instructions for causing a computer to carry out any of the methods of the second application as described above.

According to a fifth aspect of the present disclosure, there is provided a system for brokering a transaction between a first party and a second party, the system being constructed and arranged to carry out any of the methods as described above, the system comprising at least said Trusted Transaction Server (TTS) and said first and/or said second application provided by one or more computer programs, optionally recorded on a carrier, containing program instructions.

The methods described herein may be carried out by appropriate software running on appropriate computer equipment. The software may be embedded in an integrated circuit, the integrated circuit being adapted for performing, or for use in the performance of, the relevant processes. Many of the processing steps may be carried out using software running on a computing device, or dedicated hardware (such as ASICs), or a combination.

It will be appreciated that any features expressed herein as being provided “in one example” or as being “preferable” may be provided in combination with any one or more other such features together with any one or more of the aspects of the present disclosure.

### BRIEF DESCRIPTION OF DRAWINGS

Embodiments of the present disclosure will now be described by way of example with reference to the accompanying drawings, in which

FIG. 1 shows schematically an example of a data structure stored by P&P according to an embodiment of the present disclosure;

FIGS. 2 to 4 show schematically examples of data structures stored by TTS according to an embodiment of the present disclosure;

FIG. 5 shows schematically an example of the relationship between the cryptographic keys, salts and secrets according to an embodiment of the present disclosure;

FIG. 6 shows schematically an example of a payment transaction to an online merchant according to an embodiment of the present disclosure and FIG. 7 shows a sequence diagram for this example;

FIG. 8 shows schematically an example of a payment transaction for a telephone order according to an embodiment of the present disclosure and FIG. 9 shows a sequence diagram for this example;

FIG. 10 shows schematically an example of a payment transaction for settling an invoice according to an embodiment of the present disclosure and FIG. 11 shows a sequence diagram for this example;

FIG. 12 shows schematically an example of a payment transaction to a mobile merchant according to an embodiment of the present disclosure and FIG. 13 shows a sequence diagram for this example;

FIG. 14 shows schematically an example of a payment transaction for an in-app purchase according to an embodiment of the present disclosure;

FIG. 15 shows schematically an example of a payment transaction for a charity donation according to an embodiment of the present disclosure;

FIG. 16 shows schematically an example of an ATM cash withdrawal according to an embodiment of the present disclosure and FIG. 17 shows a sequence diagram for this example;

FIG. 18 shows schematically an example of a sign-up or login or similar transaction with an online service according to an embodiment of the present disclosure, and FIGS. 19 and 20 show sequence diagrams for login and sign-up respectively;

FIGS. 21 and 22 show sequence diagrams for examples of anonymous subscription according to embodiments of the present disclosure;

FIG. 23 shows schematically an example of customer registration and phone provisioning for P&P;

FIGS. 24 and 25 show schematically examples of card enrolment to P&P; and

FIG. 26 shows schematically an example of information validation according to an embodiment of the present disclosure.

### DETAILED DESCRIPTION

There follows a description of several examples of brokering a transaction between a first party and a second party with a trusted transaction server (TTS) according to embodiments of the present disclosure. In these examples, the first party is generally designated by the reference numeral 300 and the second party is generally designated by the reference numeral 100, while the TTS is designated 200.

The first party has a computer device associated therewith which runs a computer application (generally designated as “the first application” hereafter) and which is arranged to securely communicate with the TTS. As will become apparent from the specific examples, the computing device can take various forms, e.g. a mobile application, a client/server arrangement, a cloud computing arrangement, a web application, etc, and can have different functionality according to the application.

The second party (also sometimes referred to as the “user” herein) also has a computing device 800 associated therewith that runs a computer application 810 (designated “the second application” or “Phone & PIN application” (P&P) hereafter) that is arranged to securely communicate with the TTS. In the preferred embodiments, the computing device is a mobile device 800, such as a “smart phone” or other device capable of wireless communications with the TTS 200. However the application can in principle run on other computing devices, such as a PC.

The TTS 200 has communication channels for communicating with the first and second computing devices. The TTS 200 may also have communication channels for communicating with third parties or more parties as part of brokering a transaction, such as payment service providers, or validation services, etc., as will be described below. The TTS 200 can be implemented by any suitable computing apparatus, e.g. comprising a processor arranged to execute program instructions, having storage and communication adaptors for communicating with other devices, etc. The TTS 200 stores records relating to the transactions and the two parties.

The data stored by P&P 810 and at the TTS 200 and their operation is described in more detail in the following examples. Nonetheless, a brief overview is now given.

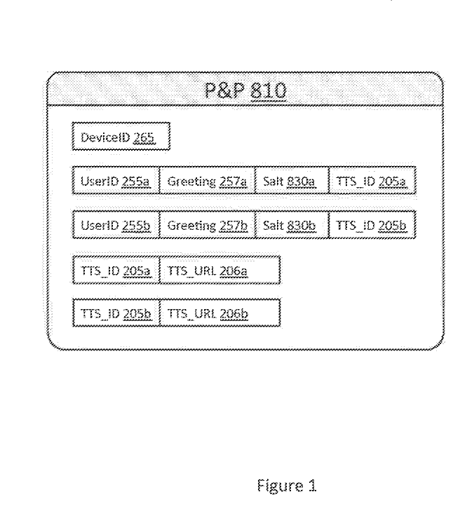

FIG. 1 shows the data structure of the data stored by P&P 810. The data includes a device identifier (DeviceID) 265, and one or more user records comprising a user identifier (UserID) 255, an optional greeting message 257, a Salt 830, and a TTS identifier (TTS_ID) 205a. The data also includes a TTS records for one or more TTS 200 comprising an identifier (TTS_ID) 205a that uniquely identifies a TTS, as well as a URL address (TTS_URL) 206a that is the URL used by P&P 810 to communicate with TTS. The functionality of P&P 810 and the use of these data items are described in more detail in relation to the following examples.

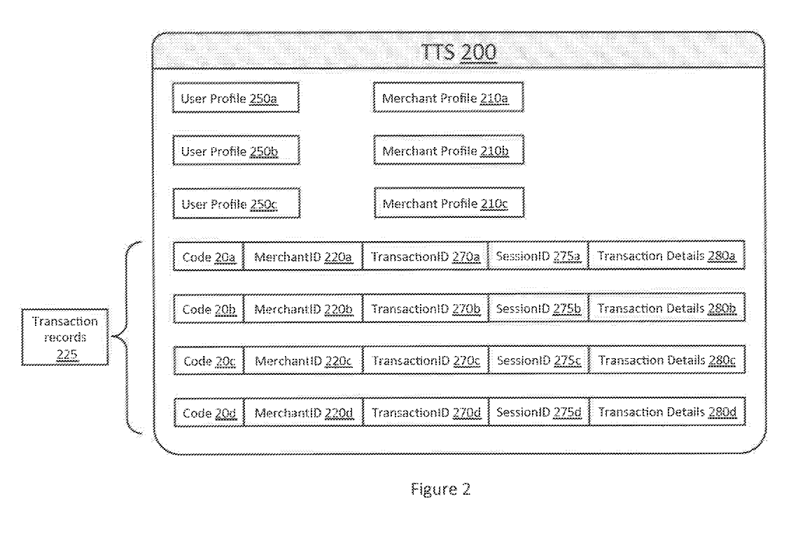

As shown by FIG. 2, the TTS 200 stores a profile for one or more first parties (Merchant Profile 210), and a profile for one or more second parties (User Profile 250), as well as storing transaction records 225. Each transaction record 225 comprises a transaction code (Code) 20, which is used to identify the transaction; a merchant identifier (MerchantID) 220 for the first party involved in the transaction; a transaction identifier (TransactionID) 270 which can be used by the first party to identify the transaction; a session identifier (SessionID) 275 to allow the first party to identify (where applicable) the computing device/session involved in the transaction, and various transaction details 280.

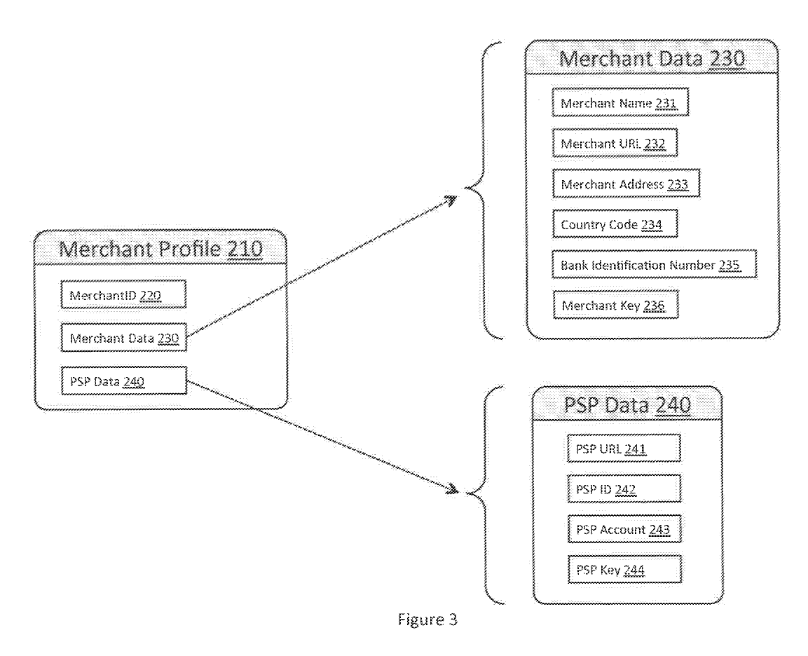

As shown by FIG. 3, the merchant profile 210 comprises a merchant identifier (MerchantID) 220, merchant data 230, and PSP data 240 relating to the payment service providers (PSPs) supported by the merchant. The merchant data 230 preferably includes the merchant name 231, the merchant URL 232, Merchant Address 233, Country Code 234, Bank Identification Number 235, and a Merchant Key 236. The PSP data preferably includes PSP URL 241, PSP ID 242, PSP Account 243, and a PSP Key (244) and is used by the TTS to communicate with the payment service providers for the merchant. It should be noted that the nomenclature used (Merchant) is for the example where the first party is a merchant, e.g. in a payment transaction scenario. Nonetheless, it will be appreciated that the data structure can be used for other scenarios not involving merchants and that no limitation to payment transactions is implied.

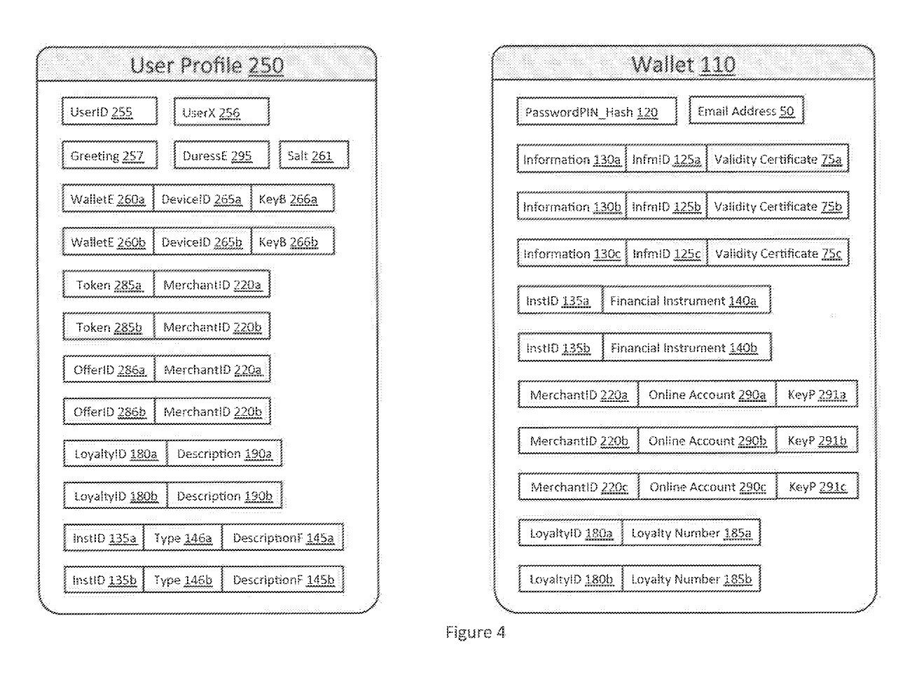

As shown by FIG. 4, the user profile 250 contains a user identifier (UserID) 255 and various items of information relating to the user. The user also has a “wallet” 110, which in some examples may be stored at the TTS 200, containing further information for the user that can be used in transactions, e.g. details of financial instruments, online service accounts, etc. In preferred embodiments, Wallet 110 is stored only in encrypted form at the TTS 200 as WalletE 260. A key 45 is generated by P&P 810 when the user authorizes TTS 200 to broker a transaction, which is used by the TTS 200 to encrypt Wallet 110, producing WalletE 260, and decrypt WalletE 260 producing Wallet 110. These items of information are discussed further in relation to the specific examples.

### Online Merchant Payment Transaction

FIG. 6 shows schematically an example of a payment transaction according to an embodiment of the present disclosure made to an online merchant 300 from a customer 100. FIG. 7 shows the steps of the transaction. The first computing device 300 associated with the merchant 300 is arranged to run an online store. The first computing device 300 comprises a webserver by which webpages for the online store can be sent/received by the customer 100 via a web browser 900 through which the customer 100 can select goods and/or services and elect to pay via P&P as follows.

Customer 100 selects ‘P&P Pay’ button and Browser 900 sends event to Merchant 300 (Step 1.1).

Merchant 300 sends transaction details and requests Code 20 from TTS 200 (Step 1.2).

TTS 200 generates unique Code 20 and sends it to Merchant 300 (Step 1.3).

Merchant 300 sends updated page with Code 20 and QR encoding of it to Browser 900 (Step 1.4).

Customer 100 transfers Code 20 from Browser 900 to P&P 810 on Phone 800 by scanning QR code or manual entry (Step 1.5).

P&P 810 sends Code 20 and UserID 255 to TTS 200, requesting transaction information (Step 1.6).

TTS 200 matches Code 20 to that sent to Merchant 300 and sends the corresponding transaction information to P&P 810 (Step 1.7).

P&P 810 displays the transaction information with a prompt to check the details and proceed if correct. Customer 100 checks the displayed details and selects option to proceed. Customer 100 then enters PIN 30 in response to prompt to enter PIN (Step 1.8).

P&P 810 sends payment request, UserID 255, DeviceID 265 and Key 45 derived from PIN 30 to TTS 200 (Step 1.9).

TTS 200 decrypts the wallet data WalletE 260 for the UserID 255 and (where applicable) for DeviceID 265, authenticates Customer 100, authenticates with 3-D Secure 510 and sends card authentication query to 3-D Secure 510 using Financial Instrument 140 data from Wallet 110 (Step 1.10).

3-D Secure 510 returns the ACS response and ACS URL to TTS 200 (Step 1.11).

TTS 200 sends PAReq to ACS 410 via 3-D Secure 510 (Step 1.12).

ACS 410 sends Acquirer 400 3DS authentication page via 3-D Secure 510 to TTS 200 (Step 1.13).

TTS 200 posts response including 3DS Password 70 from Wallet 110 to ACS 410 via 3-D Secure 510 (Step 1.14).

ACS 410 verifies the 3DS Password 70, generates a PARes and sends the PARes via 3-D Secure 510 to TTS 200 (Step 1.15).

TTS 200 validates the signature and other data of the PARes and sends a payment authorisation request to PSP 700 including ECI and CAVV (Step 1.16).

PSP 700 sends the payment authorisation request to the merchant's acquiring bank Acquirer 600 via Processor 610 (Step 1.17).

Acquirer 600 sends the payment authorisation request via Card Scheme 500 to the issuing bank Issuer 400 corresponding to Payment Card 60 (Step 1.18 and 1.19).

Issuer 400 approves the request and returns transaction confirmation via Card

Scheme 500 to Acquirer 600 (Step 1.20 and 1.21).

Acquirer 600 passes confirmation to PSP 700 via Processor 610. PSP 700 sends confirmation to TTS 200 (Step 1.22 and 1.23).

TTS 200 sends the payment confirmation, transaction token, transaction reference, SessionID 275 and optionally delivery address obtained from Wallet 110 to Merchant 300 (Step 1.24).

Merchant 300 sends updated page to Browser 900 confirming successful payment and completes the order process (Step 1.25).

TTS 200 sends payment confirmation to P&P 810 (Step 1.26).

This particular example shows a credit card transaction. Payment could be made using other financial instruments or methods, for example using direct account transfer. An example of a transaction using a direct account transfer is described in section “Settling an invoice payment transaction” relating to payment of an invoice. Furthermore, the use of 3-D Secure validation can be omitted.

If the Customer 100 has enrolled more than one Financial Instrument 140, then at Step 1.8 they will be prompted with a list of available cards or accounts to use for the payment, before entering their PIN. Furthermore the Merchant 300 can specify in the transaction details that they send at Step 1.2, the types of financial instruments that they accept for payment, for example debit cards only or direct account transfer only or all payment types. A subset of the financial instruments that Customer 100 has enrolled is then determined based on the types of financial instruments specified by Merchant 300. If there is more than one Financial Instrument 140 in this subset, then the user is prompted to make a selection, otherwise the single Financial Instrument 140 in the subset is used without requiring any user selection. See section “Multiple cards payment transaction” for more details.

Most ecommerce sites require that Customer 100 has signed in to their system before being able to checkout, see section “Anonymous subscriptions” for an example of an exception. The account associated with Customer 100 would normally include the postal address for delivery of goods to Customer 100. This address could be obtained when Customer 100 signs-up to the Merchant 100, see section “Sign-up to online service”. Alternatively the delivery address can be sent from TTS 200 to Merchant 100 at Step 1.24, thereby ensuring that Merchant 100 receives the correct up-to-date postal address. Furthermore Customer 100 then only has to manage one single change of address in Wallet 110, rather than having to login to multiple merchant sites and update their delivery address manually. Customer 100 can configure the system to always share the delivery address with any Merchant 100 that requests this at Step 1.2, or to always prompt at Step 1.8. Similarly Customer 100 can configure the system to always share their email address with Merchant 100 to receive the order receipt and subsequent delivery notifications or to always prompt at Step 1.8.

After Step 1.26 TTS 200 sends a confirmation email to Customer 100 with details of the transaction including merchant name, location where transaction approved (i.e. phone location), time and date, what information was shared with merchant but not the information itself, i.e. description of information e.g. email address, transaction type e.g. payment, login, signup and specific information relevant to that transaction e.g. login URL. Customer 100 can configure the system to always send emails for all transactions or specify for specific categories, for example payments only, payments and sign-ups. The confirmation email provides an audit trail record for the Customer 100 as well as a means of potentially detecting fraudulent activity.

At Step 1.16, TTS 200 sends a payment authorisation request to PSP 700. As an alternative, the functionality of a PSP can be incorporated into TTS 200. As a further alternative multiple PSPs could be supported so that the existing PSPs that merchants are already using for their ecommerce sites are used by the system, otherwise they would be forced to register with a single further PSP 700 that the system uses. See section “Multiple PSP” for further details.

The browser 900 used to access the online merchant's store may be running on the phone 800, or more generally, the browser 900 may be running on the same computing device as P&P 810. In this scenario, Code 20 can be communicated from Browser 900 to P&P 810 on Phone 800 automatically, without the user having to scan or manually input the code 20.

As will be appreciated, this method is not restricted to use with online merchants. The method could be used with a sale in a “bricks-and-mortar shop” or restaurant, where a Point of Sale terminal communicating with the merchant back end system replaces the browser and webserver. The transaction code can be communicated to the user in many different ways. For example, the shop assistant/restaurant staff at the Point of Sale terminal can print a QR code on an invoice for the customer to scan or display the QR code on a screen for the customer to scan, or the code can be communicated verbally, or electronically, etc.

### Encryption/Decryption

The wallet 110 is preferably stored only in encrypted form at the TTS 200 as WalletE 260. Key 45 is generated by P&P 810 when the user authorizes the TTS to broker a transaction, which is used by the TTS 200 to decrypt WalletE 260. The Key 45 can be cryptographically generated from a “secret” known to or associated with the second party or the second computing device. In the preferred examples, Key 45 is cryptographically generated by P&P 810 from the PIN entered by the user. Preferably a Salt 830 can be generated and stored on P&P 810 which can also be used by P&P in generating Key 45. Using a Salt 830 makes the Key 45 less susceptible to a brute force attack to try to derive the PIN from the Key 45. Additionally a unique hardware identifier associated with the second computing device can be used in generating Key 45 to make it impossible or at least very difficult to clone P&P 810 and its associated data in order to generate Key 45 on any other computing device. Beneficially a tamper-proof cryptographic checksum of the application code for P&P 810 can be used in generating Key 45, ensuring that application P&P 810 has not been tampered with. For security, preferably the key 45 used to decrypt the wallet 110 is not stored at either P&P or the TTS 200, but rather is generated each time the user authorizes to the TTS. Similarly, the PIN (or at least one secret) is preferably not stored on the device 800 nor communicated to the TTS 200.

The Wallet may optionally be encrypted differently for each device and associated DeviceID 265 used by the user where this functionality is supported, i.e. WalletE 260a,260b. This scheme requires that all WalletE 260 are kept synchronised, which requires that decryption keys are stored at TTS 200.

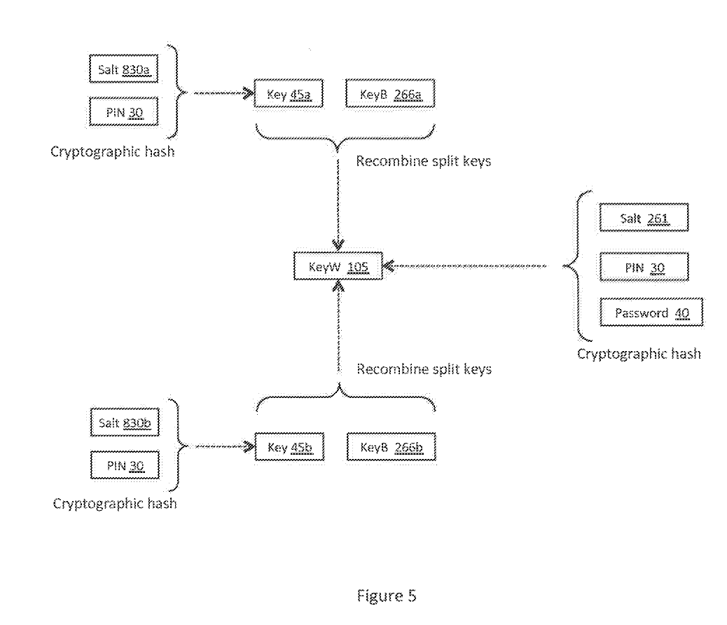

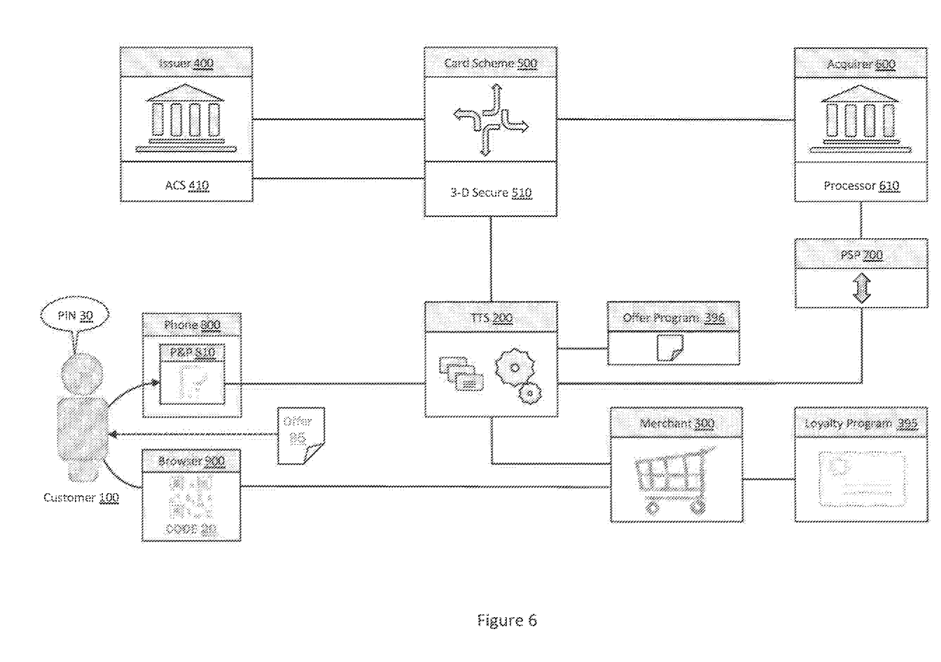

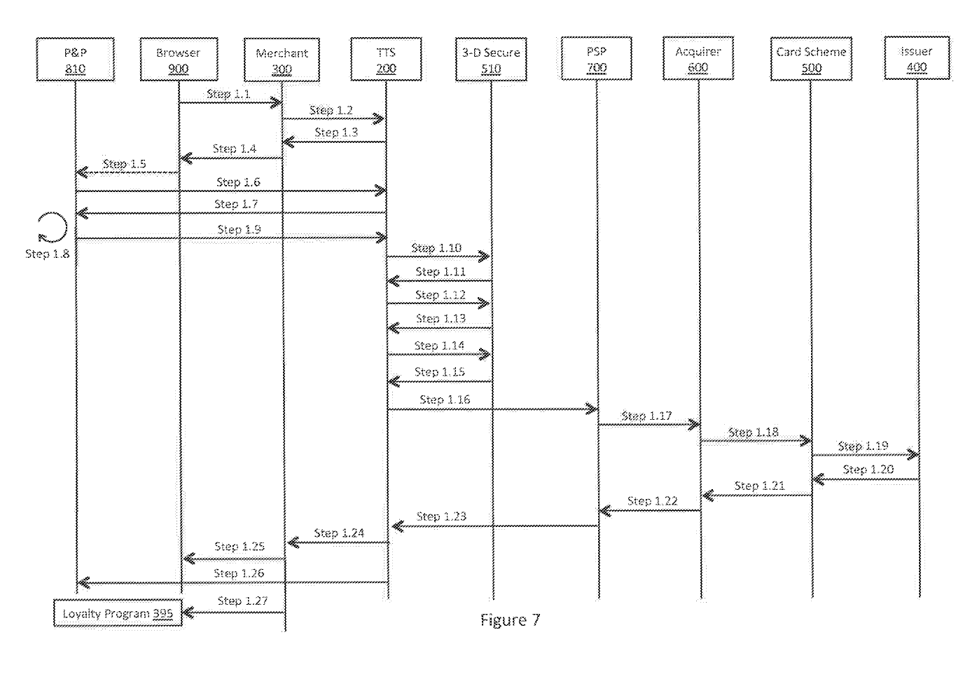

Alternatively a “split key” scheme can be used to improve security further as illustrated by FIG. 5. In this scheme, a single KeyW 105 is used to encrypt Wallet 110 and never stored. KeyW 105 is derived from Salt 261, PIN 30 and Password 40. However it is necessary to be able to decrypt Wallet 110 using only the secret PIN 30. The method beneficially enables this as follows:

KeyW 105 that is used to encrypt and decrypt the Wallet 110 is cryptographically split, with the first part, KeyB 266a, stored at TTS 200 and the second, Key 45, generated by P&P 810 each time Customer 100 enters PIN 30 and authorizes the transaction. This ensures that it is impossible for an attacker to decrypt Wallet 110 if TTS 200 is compromised because KeyW 105 is never stored and cannot be computed from data available at TTS 200. Note that the key could be split into multiple parts, and the further parts stored at alternate TTS 200, using for example Shamir Secret Sharing or Reed-Solomon codes. Salt 830a is a unique random secret that is only stored on Phone 800. Combined with using modulo exponentiation, this makes it computationally infeasible to determine the PIN from Key 45, should an attacker get access to Key 45. This method has the attractive properties of providing a high entropy key using a low entropy PIN and being able to provision P&P 810b on further devices Phone 800b with a unique random Salt 830b whilst ensuring that the correct KeyW 105 can be computed when Customer 100 enter PIN 30 on the new computing device Phone 800b.

The preferred alternative steps for achieving the split key method are:

At Step 1.9, P&P 810 computes Key 45 as:
key 45=ĝH(salt, PIN)
where PIN=PIN 30, the secret PIN entered by Customer 100;
salt=Salt 830a, the salt associated with UserID 255a;
H is a one-way cryptographic function;
̂ is exponentiation modulo N where N is a large safe prime (N=2q+1, where q is prime); g is a generator modulo N.
At Step 1.10, TTS 200 computes the wallet decryption KeyW 105 as:
keyW=key 45 XOR keyB where keyB=KeyB 266a, the partial key associated with DeviceID 265a.

### Restaurant Payment Transaction

For example, at a payment system in a restaurant, the process proceeds generally as shown in FIG. 7 with a POS operator effectively replacing the browser 900. At Step 2.1, customer 100 requests their bill and POS operator selects appropriate bill. POS 320 requests Merchant 300 to prepare Bill 310 (Step 2.1).

Merchant 300 sends transaction details, optionally request to include tip and requests Code 20 from TTS 200 (Step 2.2).

TTS 200 generates unique Code 20 and sends it to Merchant 300 (Step 2.3).

Merchant 300 sends bill details, Code 20 and QR encoding of it to POS 320 (Step 2.4).

POS 320 prints Bill 310 including Code 20 and Bill 310 is given to the Customer 100, who then transfers Code 20 to P&P 810 by scanning the QR code or manual entry (Step 2.5).

P&P 810 sends Code 20 and UserID 255 to TTS 200, requesting transaction information (Step 2.6).

TTS 200 matches Code 20 to that sent to Merchant 300 and sends the corresponding transaction information to P&P 810 (Step 2.7).

P&P 810 displays the transaction information including option to add a tip, with a prompt to check the details and proceed if correct. Customer 100 checks the displayed details, optionally enters tip and selects option to proceed. Customer 100 then enters PIN 30 in response to prompt to enter PIN (Step 2.8).

P&P 810 sends payment request, UserID 255, DeviceID 265 and Key 45 derived from PIN 30 to TTS 200 (Step 2.9).

TTS 200 decrypts the wallet data, authenticates Customer 100, authenticates with 3-D Secure 510 and sends card authentication query to 3-D Secure 510 using Financial Instrument 140 data from Wallet 110 (Step 2.10).

TTS 200 receives PARes from 3-D Secure 510 (Step 2.11) and sends a payment authorisation request to PSP 700 (Step 2.12).

PSP 700 receives payment authorisation confirmation and sends it to TTS 200 (Step 2.13).

TTS 200 sends the payment confirmation, transaction token and transaction reference to Merchant 300 (Step 2.14).

Merchant 300 sends payment confirmation to POS 320, which then optionally prints a receipt for Customer 100 (Step 2.15).

TTS 200 sends payment confirmation to P&P 810 (Step 2.16).

At Step 2.2 Merchant 100 can specify whether Customer 100 should be presented with option to enter a tip. Merchant 100 can specify a minimum amount or percentage for bills where there is a mandatory tip (for example for table of more than 10 people)

As a fraud prevention measure, TTS 200 can limit the tip amount as a percentage and/or amount and if the tip exceeds this amount, then TTS 200 can reject the payment request.

### Multiple Cards Payment Transaction

Customer 100 requests to pay using P&P. POS operator instructs POS 320 to send P&P payment request to Merchant 300 (Step 3.1).

Merchant 300 sends transaction details optionally including list of supported payment types Type 146 and requests Code 20 from TTS 200 (Step 3.2).

TTS 200 generates unique Code 20 and sends it to Merchant 300 (Step 3.3).

Merchant 300 sends Code 20 and QR encoding of it to POS 320 (Step 3.4).

POS 320 displays the transaction total and Code 20. Customer 100 transfers Code 20 from POS 320 to P&P 810 by scanning the QR code or manual entry (Step 3.5).

P&P 810 sends Code 20 and UserID 255 to TTS 200, requesting transaction information (Step 3.6).

TTS 200 matches the list of payment types Type 146 to those stored in User Profile 250 associated with UserID 255 and retrieves the descriptions of the financial instruments DescriptionF 145 associated with matching Type 146. TTS 200 matches Code 20 to that sent to Merchant 300 and sends the corresponding transaction information and list of InstID 135 and DescriptionF 145 to P&P 810 (Step 3.7).

P&P 810 displays the transaction information and list of DescriptionF 145 with a prompt to check the details, select a payment card (if more than one) and proceed if correct. Customer 100 checks the displayed details, selects preferred card DescriptionF 145 and selects option to proceed. Customer 100 then enters PIN 30 in response to prompt to enter PIN (Step 3.8).

P&P 810 sends payment request, selected InstID 135, UserID 255, DeviceID 265 and Key 45 derived from PIN 30 to TTS 200 (Step 3.9).

TTS 200 decrypts the wallet data, authenticates Customer 100, authenticates with 3-D Secure 510 and sends card authentication query to 3-D Secure 510 using Financial Instrument 140 corresponding to InstID 135 from Wallet 110 (Step 3.10).

TTS 200 receives PARes from 3-D Secure 510 (Step 3.11) and sends a payment authorisation request to PSP 700 (Step 3.12).

PSP 700 receives payment authorisation confirmation and sends it to TTS 200 (Step 3.13).

TTS 200 sends the payment confirmation, transaction token and transaction reference to Merchant 300 (Step 3.14).

Merchant 300 sends payment confirmation to POS 320, which then prints a receipt for Customer 100 (Step 3.15).

TTS 200 sends payment confirmation to P&P 810 (Step 3.16).

This process similarly applies to the scenario of vending and ticket machines, where the POS operator is Customer 100. The identity of Customer 100 is not disclosed to Merchant 300, not even with the payment transaction because of the transaction tokenisation.

If Merchant 300 does not include a list of supported payment types, then all payment types are assumed to be supported and consequently the list of InstID 135 and DescriptionF 145 will include all those in User Profile 250.

The list can be a combination of inclusive and exclusive payment types, for example “debit and credit card excluding XYZ credit cards”.

### Loyalty Card Payment Transaction

The method can also beneficially be applied to automatically use the appropriate loyalty card that Customer 100 has enrolled in a transaction with a particular merchant. The detailed steps, with reference to FIG. 6 are as follows:

Customer 100 requests to pay using P&P. POS operator instructs POS 320 to send P&P payment request to Merchant 300 (Step 4.1).

Merchant 300 sends transaction details optionally including list of LoyaltyIDs 180 corresponding to supported loyalty programs and the associated Loyalty Rewards

Points 95 available for each, and requests Code 20 from TTS 200 (Step 4.2).

TTS 200 generates unique Code 20 and sends it to Merchant 300 (Step 4.3).

Merchant 300 sends Code 20 and QR encoding of it to POS 320 (Step 4.4).

POS 320 displays the transaction total and Code 20. Customer 100 transfers Code 20 from POS 320 to P&P 810 by scanning the QR code or manual entry (Step 4.5).

P&P 810 sends Code 20 and UserID 255 to TTS 200, requesting transaction information (Step 4.6).

TTS 200 matches the list of LoyaltyIDs 180 to those stored in User Profile 250 associated with UserID 255 and retrieves the loyalty program Description 190 associated with matching LoyaltyIDs 180. TTS 200 matches Code 20 to that sent to Merchant 300 and sends the corresponding transaction information and list of LoyaltyID 180 and Description 190 to P&P 810 (Step 4.7).

P&P 810 displays the transaction information and list (if any) of Description 190 together with Loyalty Rewards Points 95 with a prompt to check the details, select a loyalty card and proceed if correct. Customer 100 checks the displayed details, selects preferred loyalty card Description 190 and selects option to proceed. Customer 100 then enters PIN 30 in response to prompt to enter PIN (Step 4.8).

P&P 810 sends payment request, selected LoyaltyID 180, UserID 255, DeviceID 265 and Key 45 derived from PIN 30 to TTS 200 (Step 4.9).

TTS 200 decrypts the wallet data, authenticates Customer 100, authenticates with 3-D Secure 510 and sends card authentication query to 3-D Secure 510 using Financial Instrument 140 data from Wallet 110 (Step 4.10).

TTS 200 receives PARes from 3-D Secure 510 (Step 4.11) and sends a payment authorisation request to PSP 700 (Step 4.12).

PSP 700 receives payment authorisation confirmation and sends it to TTS 200 (Step 4.13).

TTS 200 sends the payment confirmation, LoyaltyID 180, Loyalty Number 185, transaction token and transaction reference to Merchant 300 (Step 4.14).

Merchant 300 sends payment confirmation to POS 320 that then prints a receipt for Customer 100 (Step 4.15).

TTS 200 sends payment confirmation to P&P 810 (Step 4.16).

Merchant 300 sends Loyalty Number 185 and Loyalty Rewards Points 95 to Loyalty Program 395 to register the rewards points earned by Customer 100 (Step 4.17).

The use of loyalty cards is similarly applicable to all other payment scenarios.

### Telephone Order Payment Transaction

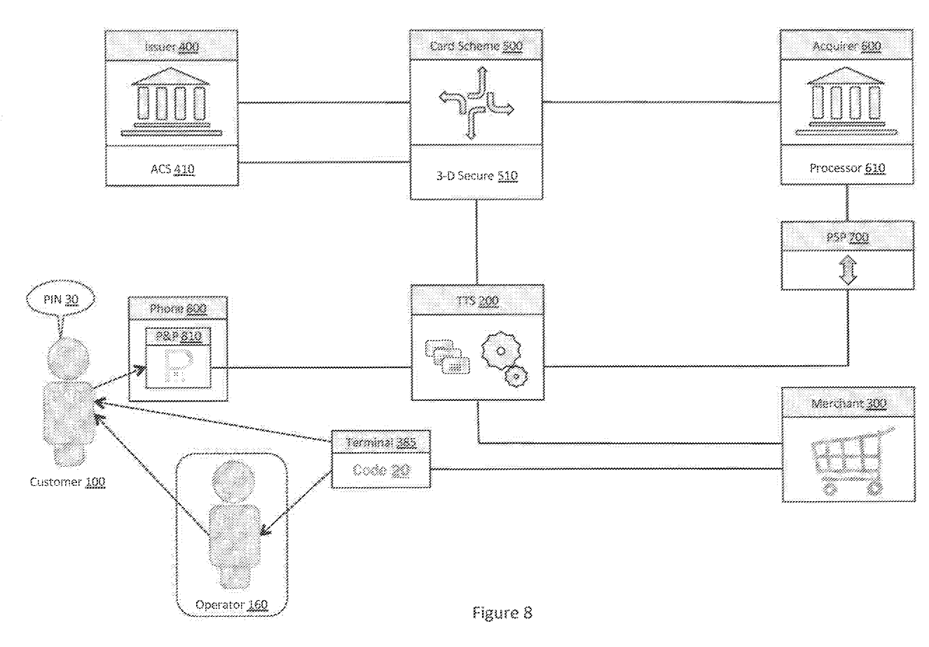

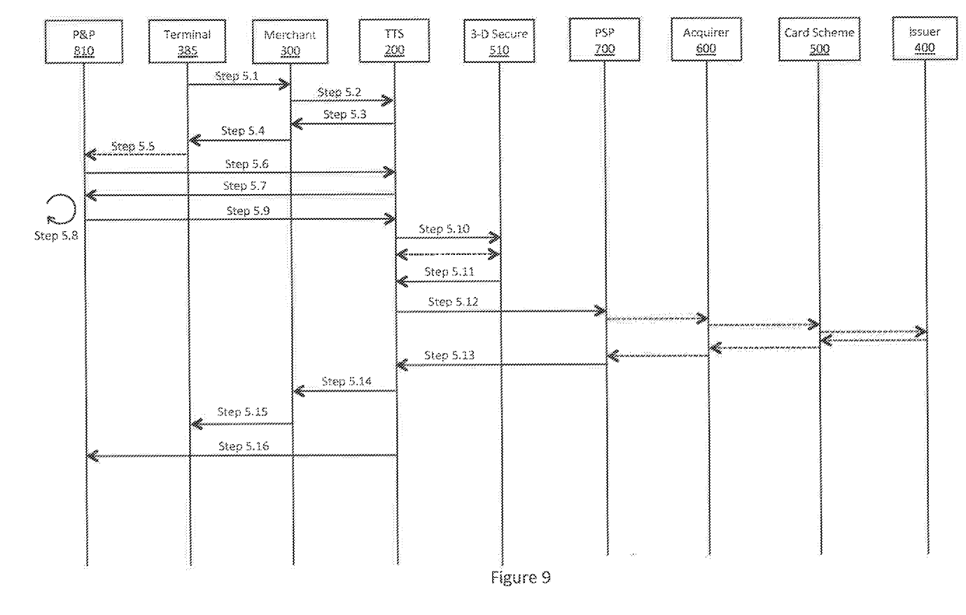

In this example, shown schematically in FIG. 8, the customer 100 makes a payment over the phone to an operator 160 operating a terminal 385 that is connected to the merchant back end computing system 300. FIG. 9 shows the steps of the transaction. The customer 100 requests to pay using P&P. The operator 160 instructs Terminal 385 to send P&P payment request to Merchant 300 (Step 5.1). The method proceeds as shown in FIG. 7, except that Merchant 300 sends Code 20 to Terminal 385 (Step 5.4) and Terminal 385 displays Code 20 and Operator 160 reads out the code to Customer 100 who enters it manually into P&P 810 (Step 5.5). Once the transaction has been completed, Merchant 300 sends payment confirmation to Terminal 385 and Operator 160 completes the order process with Customer 100 (Step 5.15).

### Settling an Invoice Payment Transaction

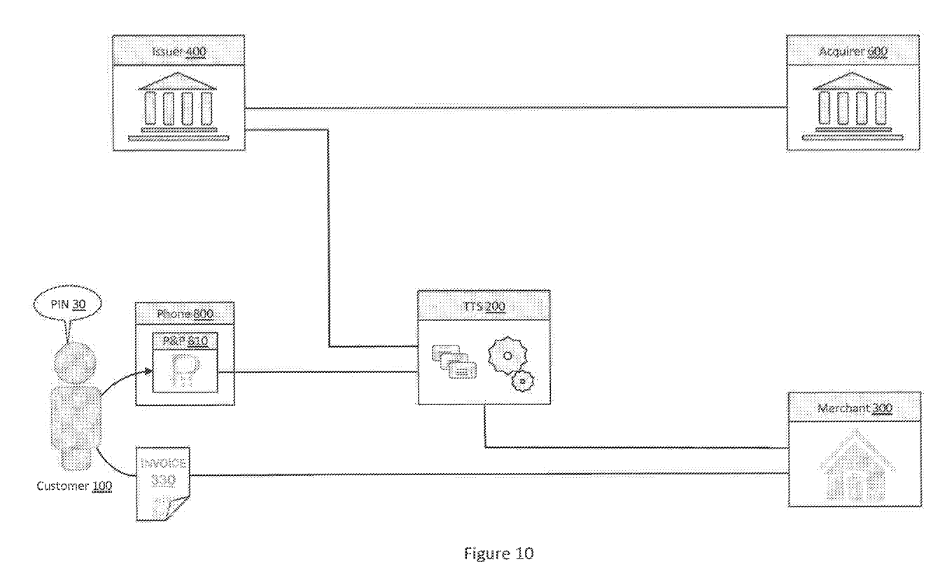

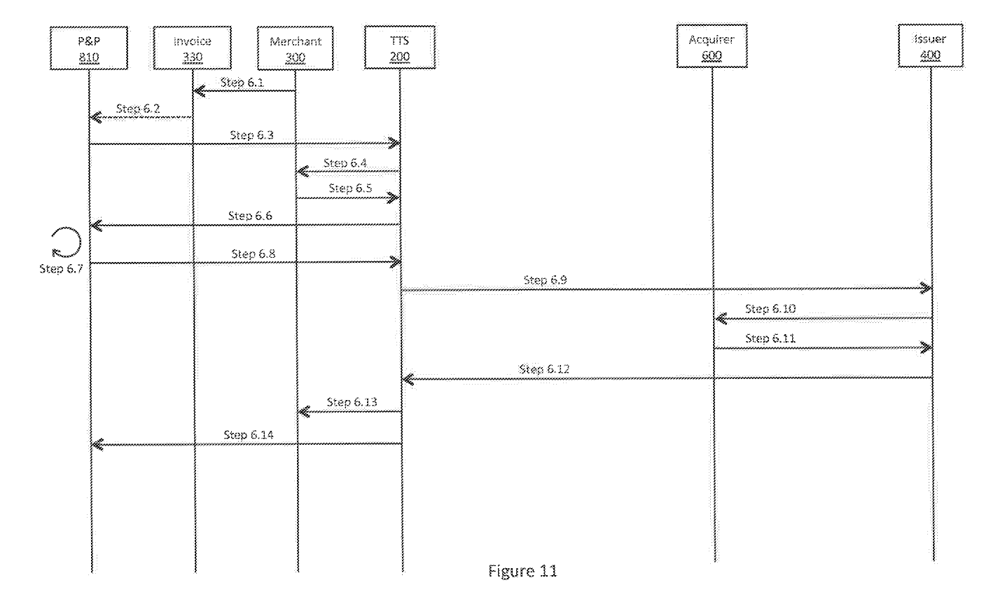

The preferred method can also be used for paying invoices. In this scenario, shown schematically in FIG. 10 with the transaction steps shown in FIG. 11, Merchant 300 prints Invoice 330 including InvoiceID 80 and a QR encoding of it, and posts Invoice 330 to Customer 100 (Step 6.1).

Customer 100 transfers InvoiceID 80 from Invoice 330 to P&P 810 by scanning the QR code or manual entry (Step 6.2).

P&P 810 sends InvoiceID 80 and UserID 255 to TTS 200, requesting transaction information (Step 6.3).

TTS 200 matches Merchant 300 to InvoiceID 80 and sends a transaction information request together with InvoiceID 80 to Merchant 300 (Step 6.4).

Merchant 300 retrieves the transaction information for InvoiceID and returns the information to TTS 200 (Step 6.5).

TTS 200 sends the transaction information to P&P 810 (Step 6.6).

P&P 810 displays the transaction information with a prompt to check the details and proceed if correct. Customer 100 checks the displayed details, and selects option to proceed. Customer 100 then enters PIN 30 in response to prompt to enter PIN (Step 6.7).

P&P 810 sends payment request, UserID 255, DeviceID 265 and Key 45 derived from PIN 30 to TTS 200 (Step 6.8).

TTS 200 decrypts the wallet data, authenticates Customer 100, and sends a payment request to Issuer 400 using account details from Wallet 110 and account details from Merchant Profile 210 associated with MerchantID 220 (Step 6.9).

Issuer 400 sends payment to Acquirer 600 together with account details for Merchant 300 (Step 6.10).

Acquirer 600 checks the payment details and if correct sends confirmation to Issuer 400 (Step 6.11).

Issuer 400 sends the payment confirmation and transaction reference to TTS 200 (Step 6.12).

TTS 200 sends payment confirmation to P&P 810 (Step 6.13).

InvoiceID is used in the same way as Code 20 to identify a transaction at the TTS and link together at the TTS the information regarding a transaction received from the first and second parties, but additionally also includes information to identify the merchant, possibly MerchantID 220, but could be some other unique identifier. It also includes the TransactionID 270. Thus the combination is unique and enables TTS 200 to determine the merchant.

This method has the advantage that the transaction details are not set up in the TTS 200 until the customer has indicated that they wish to pay the invoice via P&P. As will be appreciated, a company such as a large utility company may send out a large number of invoices in a year, only some of which will be paid by P&P. The merchant 300 generates an invoice ID for the invoice. When the customer indicates they wish to pay via P&P the transaction code is received by the TTS. The TTS then finds the merchant that matches that transaction code and gets the relevant transaction details from the merchant. This avoids the need to store details of every invoice at the TTS until necessary.

Note that this system makes a direct payment. Alternatively, payment could be made via a PSP 700 and/or using 3-D Secure by following the appropriate steps described above in relation to FIGS. 6 and 7.

The InvoiceID 80 could be a URL with invoice number as parameter so that if scanned by an application other than P&P 810 then it provides a valid URL that will take the user to Merchant 300's website where the user can login and will be able to pay their bill online. If the code is scanned with P&P 810, then the code and URL contain unique information to work as described above, for example InvoiceID 80 www.acme.com?193748367887.

### Mobile Merchant Payment Transaction

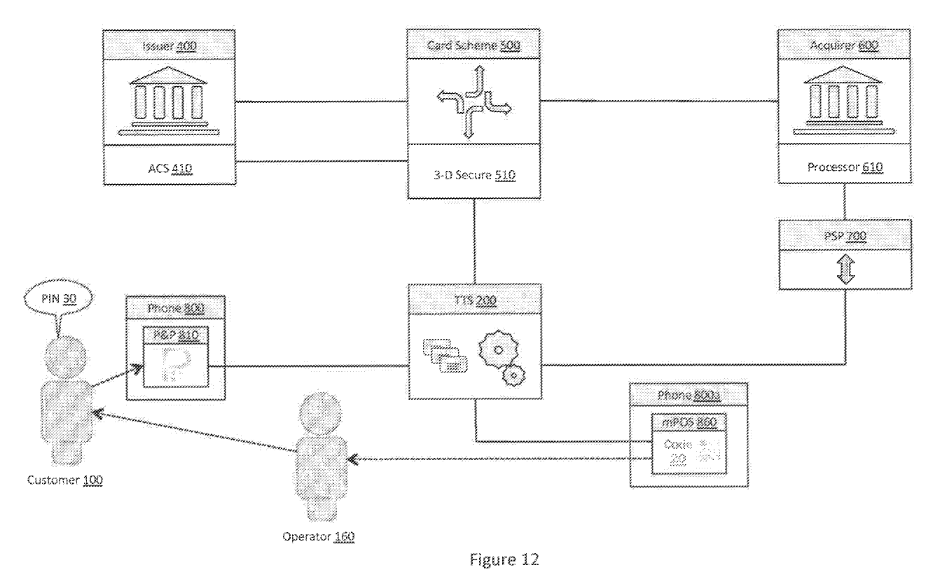

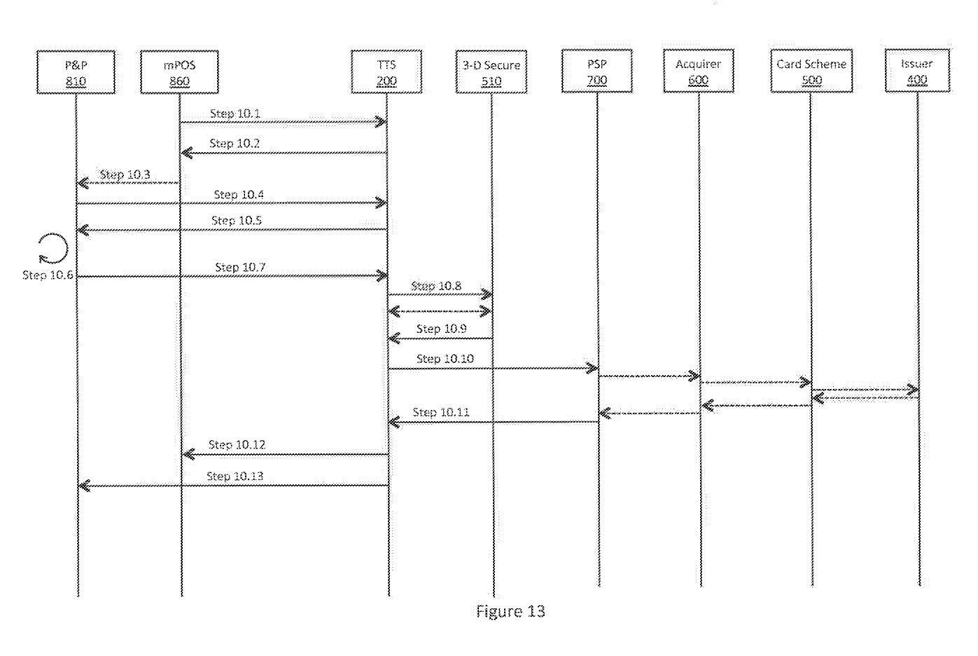

FIGS. 12 and 13 show a payment scheme where the first party is a mobile merchant. The first computing device in this example is a mobile device that runs the first application (mPOS 860) that is arranged to communicate directly with the TTS 200 and allows payments to be made via P&P, as follows:

Customer 100 requests to pay using P&P. Operator 160 enters transaction amount and mPOS 860 sends transaction details and requests Code 20 from TTS 200 (Step 10.1).

TTS 200 generates unique Code 20 and sends it to mPOS 860 (Step 10.2).

mPOS 860 displays the transaction total and Code 20. Customer 100 transfers Code 20 from mPOS 860 to P&P 810 by scanning the QR code or manual entry (Step 10.3).

P&P 810 sends Code 20 and UserID 255 to TTS 200, requesting transaction information (Step 10.4).

TTS 200 matches Code 20 to that sent to Merchant 300 and sends the corresponding transaction information to P&P 810 (Step 10.5).

P&P 810 displays the transaction information with a prompt to check the details and proceed if correct. Customer 100 checks the displayed details, and selects option to proceed. Customer 100 then enters PIN 30 in response to prompt to enter PIN (Step 10.6).

P&P 810 sends payment request, UserID 255, DeviceID 265 and Key 45 derived from PIN 30 to TTS 200 (Step 10.7).

TTS 200 decrypts the wallet data, authenticates Customer 100, authenticates with 3-D Secure 510 and sends card authentication query to 3-D Secure 510 using Financial Instrument 140 data from Wallet 110 (Step 10.8).

TTS 200 receives PARes from 3-D Secure 510 (Step 10.9) and sends a payment authorisation request to PSP 700 (Step 10.10).

PSP 700 receives payment authorisation confirmation and sends it to TTS 200 (Step 10.11).

TTS 200 sends the payment confirmation and transaction reference to mPOS 860 and Operator 160 completes the order with Customer 100 (Step 10.12).

TTS 200 sends payment confirmation to P&P 810 (Step 10.13).

This method has the advantage of allowing mobile merchants to accept payments using credit cards and other financial instruments using P&P without having to invest in the usual infrastructure, e.g. credit card Point of Sale terminals.

### In-App Purchase

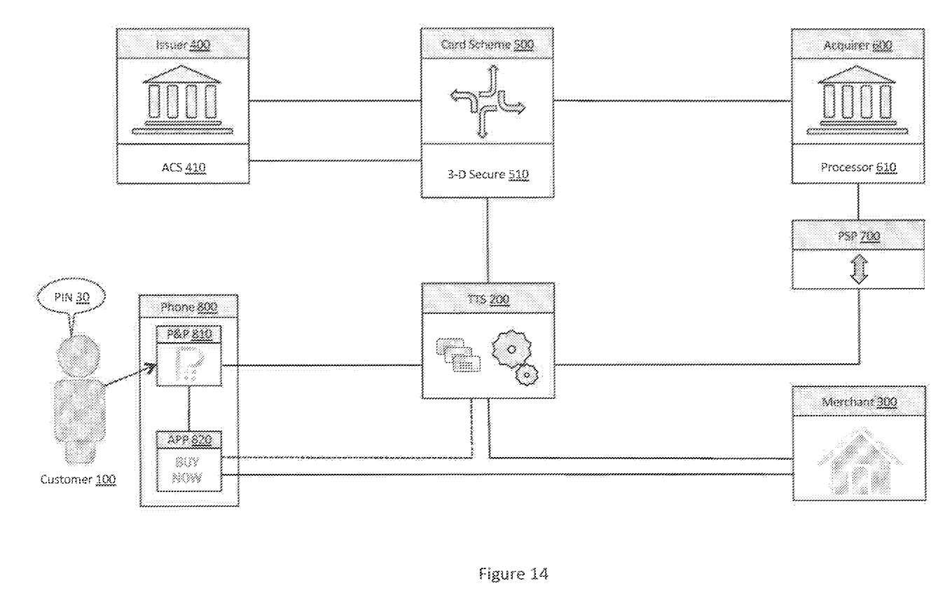

As shown by FIG. 14, the method can also be used for “In-app” purchases for applications 820 running on the mobile device 800 of the second party. In a first type, the App 820 communicates directly with the TTS 200 (shown by broken line in FIG. 14) in which case the method follows a similar flow as that shown for the mobile merchant with the App 820 taking the place of the mPOS 860. In a second type, the App 820 communicates with Merchant 300 that in turn communicates with the TTS 200 (shown by solid line in FIG. 14) in which case the method follows a similar flow as that shown for the online merchant scenario with the App 820 taking the place of the browser 900.

In both these cases, the app 820 can automatically communicate the Code 20 directly to the P&P application 810 running on the mobile device 800, rather than have Customer 100 manually enter or scan the code 20.

The method can optionally comprise an additional last step, wherein, after TTS 200 has sent payment confirmation to P&P 810 (Step 7.16), P&P 810 informs APP 820 that payment is complete (Step 7.17). This last step is not essential, but may be useful in some implementations in order to prompt App 820 to bring itself to the foreground, because at Step 7.5, P&P 810 is bought to foreground to process the interaction with TTS 200 (Steps 7.6, 7.7, 7.9, 7.16) and interact with Customer 100 at Step 7.8.

The advantage of the inter-application communication and invocation is that this approach avoids having to use a library that has to be integrated with third-party applications and use new APIs. The method uses a simple URL scheme provided by the platform for this purpose. Further benefit is that P&P 810 is a trusted application and the user is not asked to enter their PIN in some unknown application.

### Charity Donation

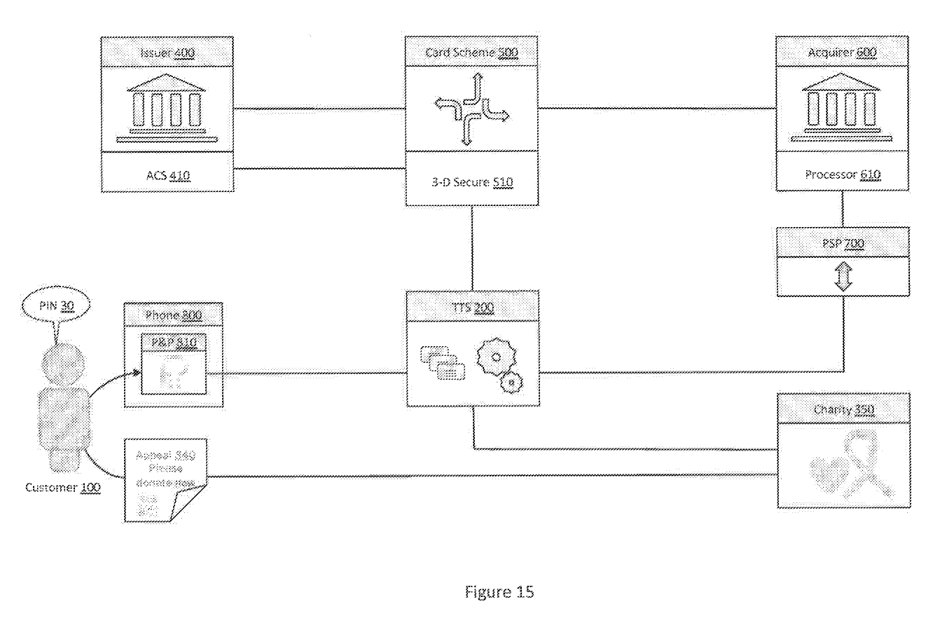

As shown by FIG. 15, the method can also be used for a charity donation. The charity produces an appeal 340 containing a unique code 20 which is advertised to the public. The code 20 can then be used by customers 100 to donate to the appeal 340 using P&P 810. The process is similar to a payment transaction. The detailed steps are as follows:

Charity 350 sends donation details, including list of optional information fields and requests Code 20 from TTS 200 (Step 13.1).

TTS 200 generates unique Code 20 and sends it to Charity 350 (Step 13.2).

Charity 350 produces Appeal 340 including Code 20 and QR encoding of it and disseminates the appeal (Step 13.3).

Customer 100 reads the Appeal 340, decides to donate and transfers Code 20 from Appeal 340 to P&P 810 by scanning the QR code or manual entry (Step 13.4).

P&P 810 sends Code 20 and UserID 255 to TTS 200, requesting transaction information (Step 13.5).

TTS 200 matches Code 20 to that sent to Charity 350 and sends the corresponding donation information to P&P 810 (Step 13.6).

P&P 810 displays the donation information and list of requested information fields with a prompt to check the details and proceed if correct. Customer 100 checks the displayed details and if desired, modifies which fields they wish to share and then enters the amount they wish to donate and selects option to proceed. Customer 100 then enters PIN 30 in response to prompt to enter PIN (Step 13.7).

P&P 810 sends payment request, UserID 255, DeviceID 265 and Key 45 derived from PIN 30 to TTS 200 (Step 13.8).

TTS 200 decrypts the wallet data, authenticates Customer 100, authenticates with 3-D Secure 510 and sends card authentication query to 3-D Secure 510 using Financial Instrument 140 data from Wallet 110 (Step 13.9).

TTS 200 receives PARes from 3-D Secure 510 (Step 13.10) and sends a payment authorisation request to PSP 700 (Step 13.11).

PSP 700 receives payment authorisation confirmation and sends it to TTS 200 (Step 13.12).

TTS 200 retrieves Information 130 fields from Wallet 110 that Customer 100 approved for sharing and informs Charity 350 that a donation has been made together with the donation amount and the retrieved Information 130 fields (Step 13.13).

TTS 200 sends payment confirmation to P&P 810 (Step 13.14).

Alternatively the method of payment could be a direct bank account transfer. In this case, rather than using a PSP 700, the payment is made directly through the issuer 400 by a process similar to that described for the invoice payment scenario (steps 6.9 to 6.12). This is particularly attractive for Charities because inter bank transfers are free of charge in many countries.

Optional Steps:

At Step 13.7 if the Charity 350 can claim tax relief on behalf of donors, an opt-out is displayed together with explanation that if donor is a taxpayer and they do not opt out then their name and address will be provided to the Charity and tax relief claimed on their behalf.

At Step 13.7, if requested by Charity 350 at Step 13.1, an optional message can be entered by Customer 100 that will then be sent to the Charity 350.

### Multiple PSP

As a further alternative to the payment systems described, multiple PSPs can be supported using the data stored in the Merchant Profile 210 as shown in FIGS. 3 and 6. When Merchant 300 registers with TTS 200 to use the P&P service, Merchant Profile 210 and MerchantID 220 are created and Merchant 300 provides details of their acquiring bank Acquirer 600, their merchant account details with Acquirer 600 and PSP 700 details, all of which are stored in the Merchant Profile 210 associated with MerchantID 220. The information for PSP 700 includes PSP URL 241 as well as further information necessary to allow TTS 200 to communicate with PSP 700 on behalf of Merchant 300.

Each Merchant 300 is thus associated with a PSP 700. Multiple Merchants may be associated with the same PSP. In this way Merchant 300a is associated with PSP 700a, Merchant 300b is associated with PSP 700b and Merchant 300c is associated with PSP 700c. Each PSP 700 has a unique PSP URL 241 and protocol for communication with merchant systems. The protocols may be proprietary.

With reference to the steps described in section “Online merchant payment transaction”, these are the alternative steps for a payment system that supports multiple PSPs:

TTS 200 retrieves Merchant Profile 210a for MerchantID 220a provided by Merchant 300a and extracts details for PSP 700a from the profile. The details provide TTS 200 with the URL, credentials and protocol information to access PSP 700a. TTS 200 validates the signature and other data of the PARes and sends a payment authorisation request to PSP 700a including ECI and CAVV (Step 1.6).

PSP 700a sends the payment authorisation request to the merchant's acquiring bank Acquirer 600a via Processor 610a (Step 1.7).

Acquirer 600a sends the payment authorisation request via Card Scheme 500 to the issuing bank Issuer 400 corresponding to Payment Card 60 (Step 1.18 and 1.19).

Issuer 400 approves the request and returns transaction confirmation via Card Scheme 500 to Acquirer 600a (Step 1.20 and 1.21).

Acquirer 600a passes confirmation to PSP 700a via Processor 610a. PSP 700a sends confirmation to TTS 200 (Step 1.22 and 1.23).

### ATM Cash Withdrawal

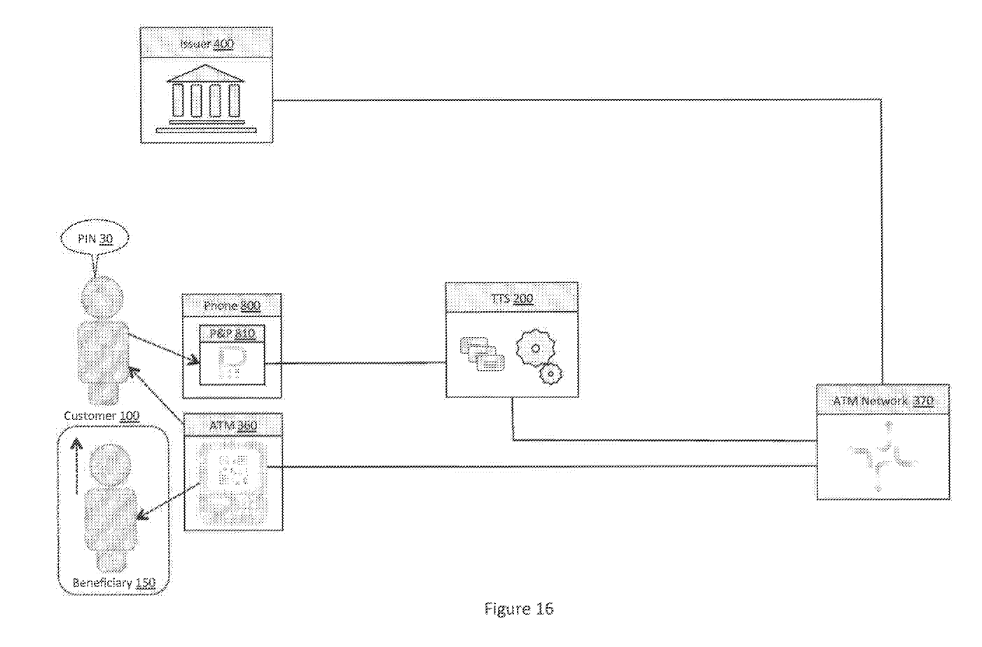

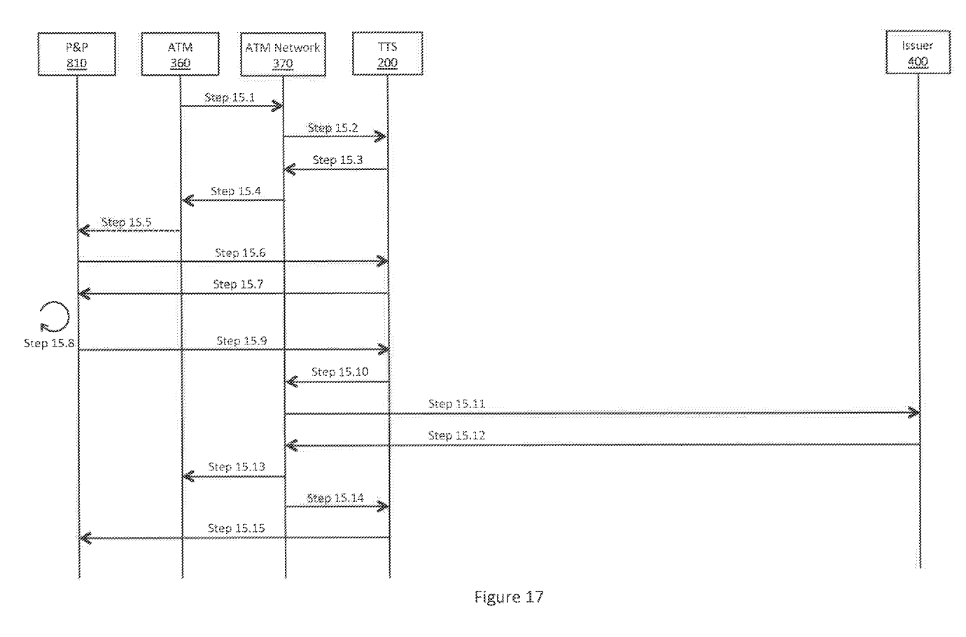

As shown in FIGS. 16 and 17, the method can also be used to withdraw cash from an ATM; the detailed steps are as follows:

Customer 100 selects option to withdraw cash using P&P on ATM 360 and enters the amount to withdraw. ATM 360 sends P&P request, withdrawal amount and ATM details to ATM Network 370 (Step 15.1).

ATM Network 370 requests Code 20 from TTS 200 (Step 15.2).

TTS 200 generates unique Code 20 and sends it to ATM Network 370 (Step 15.3).

ATM Network 370 sends Code 20 and QR encoding of it to ATM 360 that then displays both codes (Step 15.4).

Customer 100 transfers Code 20 from ATM 360 to P&P 810 by scanning the QR code or manual entry (Step 15.5).

P&P 810 sends Code 20 and UserID 255 to TTS 200, requesting transaction information (Step 15.6).

TTS 200 matches Code 20 to that sent to ATM Network 370 and sends the corresponding transaction information to P&P 810 (Step 15.7).

P&P 810 displays the transaction information with a prompt to check the details and proceed if correct. Customer 100 checks the displayed details, and selects option to proceed. Customer 100 then enters PIN 30 in response to prompt to enter PIN (Step 15.8).

P&P 810 sends withdrawal request, UserID 255, DeviceID 265 and Key 45 derived from PIN 30 to TTS 200 (Step 15.9).

TTS 200 decrypts the wallet data, authenticates Customer 100, retrieves Financial Instrument 140 from Wallet 110 and sends a withdrawal request to ATM Network 370 that includes the withdrawal amount and Financial Instrument 140 (Step 15.10).

ATM Network 370 sends the request to Issuer 400 corresponding to Financial Instrument 140 (Step 15.11).

Issuer 400 processes the transaction and sends authorisation to ATM Network 370 (Step 15.12).

ATM Network 370 sends authorisation to ATM 360 that then dispenses the cash (Step 15.13).

ATM Network 370 sends withdrawal confirmation to TTS 200 (Step 15.14).

TTS 200 sends withdrawal confirmation to P&P 810 (Step 15.15).

An alternative to entering the amount of cash to be withdrawn at Step 15.1 is to enter the amount in P&P 810 at Step 15.8.

A particularly convenient alternative method allows a beneficiary 150 to withdraw cash at an ATM and the customer 100 authorises the withdrawal from customer 100's bank account. Customer 100 can be physically remote from the ATM. In this alternative, at Step 15.1, beneficiary 150 selects an option to withdraw cash using P&P on ATM 360 and enters the amount to withdraw. At Step 15.5 beneficiary 150 reads out Code 20 to Customer 100 who enters it manually into P&P 810. Alternatively beneficiary 150 could scan Code 20 and send it by SMS or other means to Customer 100.

It will be appreciated that the concept of having a different customer 100 and beneficiary 150 can be applied to any of the scenarios described herein. In general, the beneficiary 150 will initiate the transaction with the first party and will communicate the transaction code 20 to the customer 100. The customer 100 will then authenticate and authorise the transaction via P&P 810 on behalf of the beneficiary 150.

### Login to Online Service

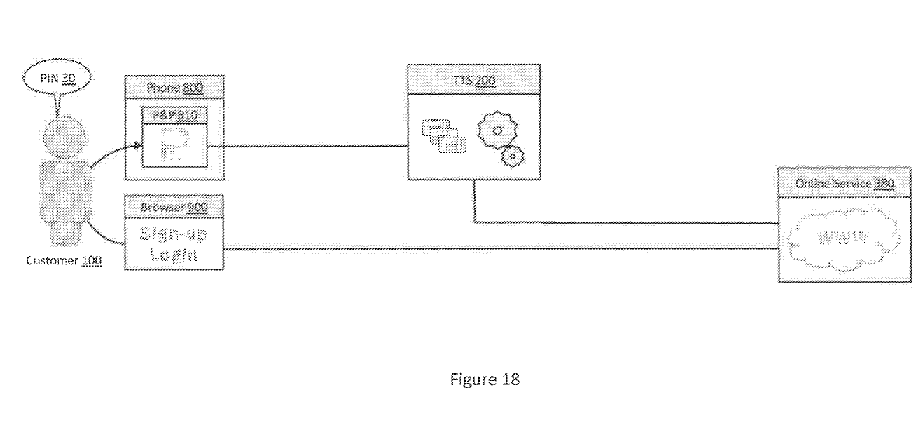

As shown in FIGS. 18 and 19, the method can also be used to securely login to an online service; the detailed steps are as follows:

Customer 100 selects ‘P&P Login’ button and Browser 900 sends event to Online Service 380 (Step 16.1).

Online Service 380 sends transaction details and requests Code 20 from TTS 200 (Step 16.2).

TTS 200 generates unique Code 20 and sends it to Online Service 380 (Step 16.3).

Online Service 380 sends updated page with Code 20 and QR encoding of it to Browser 900 (Step 16.4).

Customer 100 transfers Code 20 from Browser 900 to P&P 810 on Phone 800 by scanning QR code or manual entry (Step 16.5).

P&P 810 sends Code 20 and UserID 255 to TTS 200, requesting transaction information (Step 16.6).

TTS 200 matches Code 20 to that sent to Online Service 380 and sends the corresponding transaction information to P&P 810 (Step 16.7).

P&P 810 displays the transaction information with a prompt to check the details and proceed if correct. Customer 100 checks the displayed details and selects option to proceed. Customer 100 then enters PIN 30 in response to prompt to enter PIN (Step 16.8).

P&P 810 sends login request, UserID 255, DeviceID 265 and Key 45 derived from PIN 30 to TTS 200 (Step 16.9).

TTS 200 decrypts the wallet data, authenticates Customer 100 and sends login confirmation to P&P 810 (Step 16.10).

TTS 200 retrieves Online Account 290 associated with MerchantID 220 for Online Service 380 from Wallet 110 and sends Online Account 290 together with authentication confirmation to Online Service 380 (Step 16.11).

Online Service 380 completes login for Online Account 290 and sends updated page to Browser 900 (Step 16.12).

This method enables anonymous login because Customer 100's identity is not disclosed, assuming of course that their identity was not provided when the account was created, see next section “Sign-up to online service”.

Alternatively rather than using Online Account 290, namely information that is unique to Online Service 380, to identify the account, other unique information that identifies Customer 100, for example email address, is used at Step 16.11.

The Online Service 380 can request information fields at Step 16.2 and these could be optional or mandatory. For example proof of age could be required to access the site. This could have been established at time of sign-up, or done at each login.

Login can also be used with a mobile application 820 running on the mobile device 800. The process is similar to that described above except that beneficially App 820, which replaces Browser 900, automatically communicates the Code 20 directly to the P&P App 810 running on the mobile device 800, rather than having customer 100 manually enter or scan the code.

Alternatively, the mobile App 820 can communicate directly with the TTS 200, rather than via the Online Service 380.

### Sign-Up to Online Service

As shown in FIGS. 18 and 20, the method can also be used to securely sign-up to an online service; the detailed steps are as follows:

Customer 100 selects ‘P&P Sign-up’ button and Browser 900 sends event to Online Service 380 (Step 17.1).

Online Service 380 sends sign-up request including a list of information fields and requests Code 20 from TTS 200 (Step 17.2).

TTS 200 generates unique Code 20 and sends it to Online Service 380 (Step 17.3).

Online Service 380 sends updated page with Code 20 and QR encoding of it to Browser 900 (Step 17.4).

Customer 100 transfers Code 20 from Browser 900 to P&P 810 on Phone 800 by scanning QR code or manual entry (Step 17.5).

P&P 810 sends Code 20 and UserID 255 to TTS 200, requesting transaction information (Step 17.6).

TTS 200 matches Code 20 to that sent to Online Service 380 and sends the corresponding sign-up information to P&P 810 (Step 17.7).

P&P 810 displays the sign-up information and list of requested information fields with a prompt to check the details and proceed if correct. Customer 100 checks the displayed details and if desired, modifies which fields they wish to share and then selects option to proceed. Customer 100 then enters PIN 30 in response to prompt to enter PIN (Step 17.8).

P&P 810 sends sign-up request, list of approved fields for sharing, UserID 255, DeviceID 265 and Key 45 derived from PIN 30 to TTS 200 (Step 17.9).

TTS 200 decrypts the wallet data, authenticates Customer 100, retrieves Information 130 fields from Wallet 110 and sends a sign-up authorisation and the Information 130 fields that Customer 100 approved for sharing to Online Service 380 (Step 17.10).

Online Service 380 creates Online Account 290 and sends it to TTS 200 (Step 17.11).

TTS 200 stores Online Account 290 and MerchantID 220 associated with Online Service 380 in Wallet 110, and sends sign-up confirmation to P&P 810 (Step 17.12).

Online Service 380 sends updated page to Browser 900 confirming sign-up (Step 17.13).

Online Service 380 can set the requested fields as mandatory or optional. Customer 100 has the option to not allow sharing of the optional fields, whereas the mandatory fields do not have this option. If Customer 100 does not wish to share any of the mandatory fields then they have the option to cancel the sign-up process without any information being shared with Online Service 380.

The requested fields can be indirect questions or information rather than sharing specific information. For example ‘Are you over 21?’ or ‘Age’ rather than having to share actual date of birth.

As an alternative the method can be used to register or ‘bind’ an already existing online account with Online Service 380, which Customer 100 is already signed in to, for subsequent use to login to the online account with Online Service 380. The alternative steps are:

Online Service 380 verifies that Information 130 fields, if requested, match those associated with Online Account 290 and sends Online Account 290 to TTS 200 (Step 17.11).

Additionally Online Service 380 could require further user authentication to approve the registration using means already configured for that account, for example multi-factor authentication using smartcard or OTP devices.

### Transaction Authorisation for Online Service

The method can also be used to securely approve transactions for an online service to which Customer 100 is already signed in, for example online banking and approving setting up a new payment beneficiary. With reference to FIG. 18, the detailed steps are as follows:

Customer 100 selects ‘P&P Approve’ button and Browser 900 sends event to Online Service 380 (Step 20.1).

Online Service 380 sends transaction details, Online Account 290 and requests Code 20 from TTS 200 (Step 20.2).

TTS 200 generates unique Code 20 and sends it to Online Service 380 (Step 20.3).

Online Service 380 sends updated page with Code 20 and QR encoding of it to Browser 900 (Step 20.4).

Customer 100 transfers Code 20 from Browser 900 to P&P 810 on Phone 800 by scanning QR code or manual entry (Step 20.5).

P&P 810 sends Code 20 and UserID 255 to TTS 200, requesting transaction information (Step 20.6).

TTS 200 matches Code 20 to that sent to Online Service 380 and sends the corresponding transaction information to P&P 810 (Step 20.7).

P&P 810 displays the transaction information with a prompt to check the details and proceed if correct. Customer 100 checks the displayed details and selects option to proceed. Customer 100 then enters PIN 30 and optionally Password 40 if Online Service 380 requested strong authentication in response to prompt to enter PIN (Step 20.8).

P&P 810 sends transaction approval, UserID 255, DeviceID 265, Key 45 derived from PIN 30 and PasswordPIN_Hash 120 derived from PIN 30 and Password 40 to TTS 200 (Step 20.9).

TTS 200 decrypts the wallet data using key 45 and further authenticates Customer 100 using PasswordPIN_Hash 120, retrieves Online Account 290 associated with MerchantID 220 for Online Service 380 from Wallet 110 and verifies that it matches Online Account 290 sent by Online Service 380. If it matches, TTS 200 sends transaction authorisation to P&P 810 (Step 20.10).

TTS 200 sends transaction authorisation to Online Service 380 (Step 20.11).

Online Service 380 sends updated page to Browser 900 confirming transaction approval (Step 20.12).

Alternatively at Steps 20.10 and 20.11, TTS 200 retrieves Online Account 290 associated with Online Service 380 and sends it to Online Service 380 and Online Service 380 verifies that it matches Online Service 290.

To meet regulatory compliance, auditing or non-repudiation requirements the method can beneficially digitally sign the transaction that Customer 100 has authorised. At Step 20.10 TTS 200 retrieves KeyP 291a associated with MerchantID 220 and Online Account 290, digitally signs the transaction and sends the signed transaction to Online Service 380.

KeyP 291a is added to the wallet of Customer 100 when Customer 100 signs-up for the online service as described for example in “Sign-up to online service”. Alternatively KeyP 291a is added as a distinct transaction that is approved by Customer 100.

An alternative to transaction authorisation is to approve sharing personal Information 130 from Wallet 110 with Online Service 380, for example online airline check-in that requires passport details for Customer 100. At Step 20.2 Online Service 380 sends a list of required information fields. At Step 20.8 the list of fields is displayed for Customer 100 to review and approve for sharing with Online Service 380. At Step 20.10 TTS 200 retrieves the approved Information 130 fields from Wallet 110 and sends them to Online Service 380.

### Anonymous Subscriptions

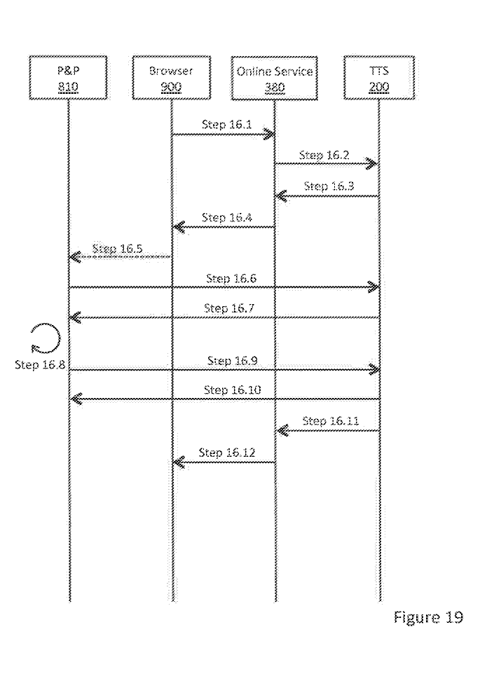

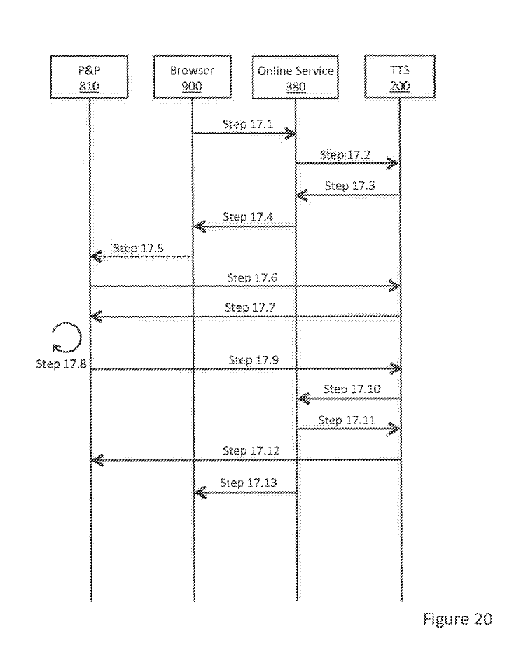

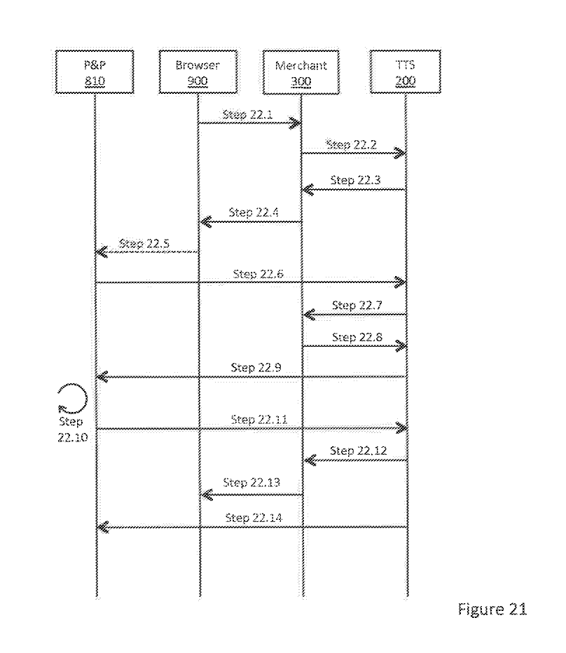

The method can beneficially be used to anonymously subscribe to and access multi-media content for example newspaper or crosswords or pay-per-view content for example film or television. As shown in FIGS. 18 and 21, the method to anonymously access an online subscription service is detailed as follows:

Customer 100 selects ‘P&P Access’ button and Browser 900 sends event to Merchant 300 (Step 22.1).

Merchant 300 sends transaction details and requests Code 20 from TTS 200 (Step 22.2).

TTS 200 generates unique Code 20 and sends it to Merchant 300 (Step 22.3).

Merchant 300 sends updated page with Code 20 and QR encoding of it to Browser 900 (Step 22.4).

Customer 100 transfers Code 20 from Browser 900 to P&P 810 on Phone 800 by scanning QR code or manual entry (Step 22.5).

P&P 810 sends Code 20 and UserID 255 to TTS 200, requesting transaction information (Step 22.6).

TTS 200 matches Code 20 to that sent to Merchant 300, searches User Profile 250 associated with UserID 255 for MerchantID 220 associated with Merchant 300, and sends Token 285 to Merchant 300 (Step 22.7).

Merchant 300 checks the validity of Token 285 and sends transaction details to TTS 200 (Step 22.8).

TTS 200 sends the transaction information to P&P 810 (Step 22.9).

P&P 810 displays the transaction information with a prompt to check the details and proceed if correct. Customer 100 checks the displayed details and selects option to proceed. Customer 100 then enters PIN 30 in response to prompt to enter PIN (Step 22.10).

P&P 810 sends access request, UserID 255, DeviceID 265 and Key 45 derived from PIN 30 to TTS 200 (Step 22.11).

TTS 200 authenticates Customer 100 and sends authentication confirmation to Merchant 300 (Step 22.12).

Merchant 300 grants access for Customer 100 and sends updated page to Browser 900 (Step 22.13).

TTS 200 sends access confirmation to P&P 810 (Step 22.14).

Merchant 300 does not have access to the identity of Customer 100, nor does Customer 100 have to have an online account for Merchant 300. Customer 100 can access the service using a different (second) Phone 800a and still gain access to the service because the access Token 285 is stored by TTS 200 in the User Profile 250 for UserID 255 associated with Customer 100.

This same process is equally applicable for a door entry system, where the Customer 100 signs up at a website for gaining authorisation to access the door. Then once Customer 100 has the Token 285 they can easily gain access to the door. This method enables both anonymous and identified access.

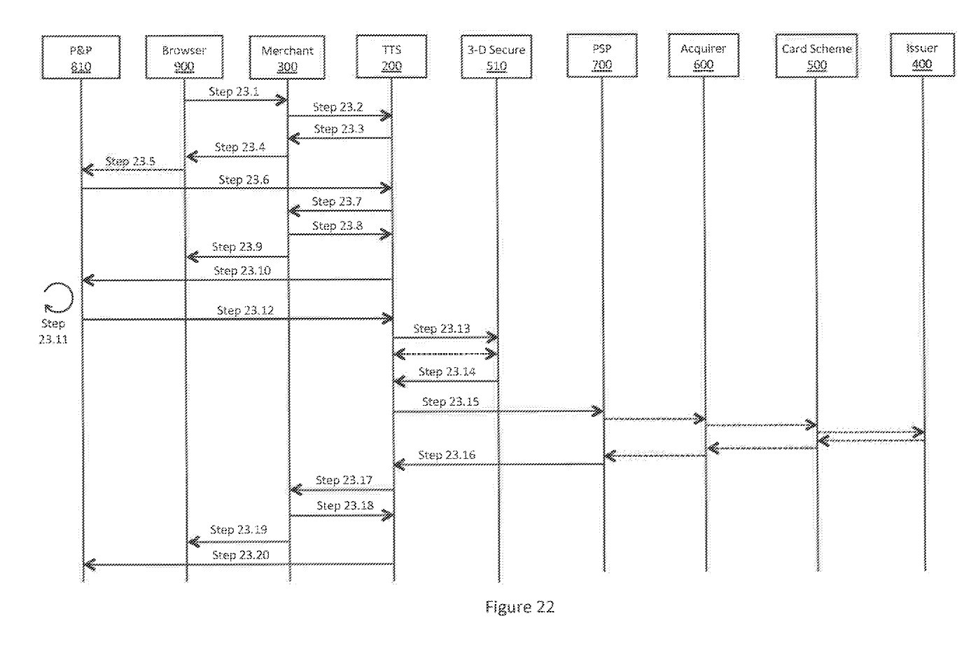

As shown in FIGS. 6 and 22, the method to anonymously subscribe to and access an online subscription service is detailed as follows:

Customer 100 selects ‘P&P Access’ button and Browser 900 sends event to Merchant 300 (Step 23.1).

Merchant 300 sends transaction details and requests Code 20 from TTS 200 (Step 23.2).

TTS 200 generates unique Code 20 and sends it to Merchant 300 (Step 23.3).

Merchant 300 sends updated page with Code 20 and QR encoding of it to Browser 900 (Step 23.4).

Customer 100 transfers Code 20 from Browser 900 to P&P 810 on Phone 800 by scanning QR code or manual entry (Step 23.5).

P&P 810 sends Code 20 and UserID 255 to TTS 200, requesting transaction information (Step 23.6).

TTS 200 matches Code 20 to that sent to Merchant 300, searches User Profile 250 associated with Customer 100 for Token 285 associated with Merchant 300, and sends response to Merchant 300 that no valid token was found (Step 23.7).

Merchant 300 determines applicable cost for access and sends revised transaction details to TTS 200 (Step 23.8).

Merchant 300 sends updated page to Browser 900 providing information on access and cost (Step 23.9).

TTS 200 sends the transaction information to P&P 810 (Step 23.10).

P&P 810 displays the transaction information with a prompt to check the details and proceed if correct. Customer 100 checks the displayed details and selects option to proceed. Customer 100 then enters PIN 30 in response to prompt to enter PIN (Step 22.11).

P&P 810 sends access request, UserID 255, DeviceID 265 and Key 45 derived from PIN 30 to TTS 200 (Step 22.12).

TTS 200 decrypts the wallet data, authenticates Customer 100, authenticates with 3-D Secure 510 and sends card authentication query to 3-D Secure 510 using Financial Instrument 140 data from Wallet 110 (Step 23.13).

TTS 200 receives PARes from 3-D Secure 510 (Step 23.14) and sends a payment authorisation request to PSP 700 (Step 23.15).

PSP 700 receives payment authorisation confirmation and sends it to TTS 200 (Step 23.16).

TTS 200 sends the payment confirmation, transaction token and transaction reference to Merchant 300 (Step 23.17).

Merchant 300 sends Token 285 to TTS 200. TTS 200 stores Token 285 and MerchantID 220 in User Profile 250 associated with UserID 255 (Step 23.18).

Merchant 300 grants access for Customer 100 and sends updated page to Browser 900 (Step 23.19).

TTS 200 sends access confirmation to P&P 810 (Step 23.20).

### Offer Redemption and Tracking

As shown in FIGS. 6 and 8, the method can also be used to track offers that Customer 100 redeems with Merchant 300; the detailed steps are as follows:

Customer 100 requests to redeem Offer 85 and pay using P&P. POS Operator 160 enters the Offer 85 and instructs POS 320 to send P&P payment request to Merchant 300 (Step 24.1).

Merchant 300 sends transaction details, including Offer 85 and requests Code 20 from TTS 200 (Step 24.2).

The method proceeds as for a normal payment transaction, for example Steps 1.3 to 1.26 in section “Online merchant payment transaction”. After the TTS 200 has received confirmation that the payment transaction has completed, TTS 200 sends confirmation to registered Offer Program 396 that UserX 256 has redeemed Offer 85 with Merchant 300 (Step 24.27).

UserID 255 is not used because it is possible (though difficult) to deduce Customer 100 email address (and hence possibly their identity) using for example rainbow tables. UserX 256 on the other hand is a unique identifier that is derived without using any information related to Customer 100 at all. This enables the Offer Program 396 to track UserX 256 activity without having to disclose the identity of Customer 100 or provide any information that could allow a third party to deduce any personal or financial information about UserX 256. Thus, the Offer Program 396 can track take up of the offer 85 anonymously.

As an alternative, UserX 256 could be sent to Merchant 300 to similarly enable anonymous tracking of Offer 85 associated with Customer 100 or to further share the Offer 85 information and UserX 256 to a third party registered to receive the offer tracking information.

As an alternative, Customer 100 may already have offers 85 stored in User Profile 250 at the TTS 220. In this case, the payment transaction starts normally. At Step 1.7 where the TTS matches Codes 20, alternatively TTS 200 searches User Profile 250 associated with UserID 255 for MerchantID 220 associated with Merchant 300, and sends any matching OfferID 286 to Merchant 300 (Step 25.7). The Merchant 300 checks the validity of OfferID and redeems the offer if valid, then sends revised transaction details to TTS 200 (Step 25.8). Merchant 300 sends the offer information to POS 320 and POS 320 displays the revised transaction total (Step 25.9). TTS 200 sends the transaction information to P&P 810 (Step 25.10). The payment transaction then proceeds as normal, with the user checking the transaction details, authenticating and authorising the transaction. Once the TTS 200 receives confirmation that the payment has been successful, TTS 200 sends confirmation to registered Offer Program 396 that UserX 256 has redeemed Offer 85 with Merchant 300 (Step 25.27).

Multiple third parties could be registered to receive offer tracking information, and TTS 200 determines which third party to send the information to, based on information obtained from the offer.

### Pre-Payment Authorisation

The method can also be used for a pre-payment authorisation for example to open a ‘tab’ at a bar or restaurant using a mobile application App 820 that is provided by the Merchant 300.

Customer 100 requests to open a tab using mobile application App 820 and enters the requested tab amount. App 820 sends the request and amount to Merchant 300 (Step 7.1).

The method proceeds in a similar way as the payment scenario described in section “In-app purchase”, except that instead of the TTS 200 sending a request for a payment to the PSP 700, the TTS 200 sends a request for a pre-payment authorisation request.

Customer 100 may later choose to close their tab and pay the outstanding amount on the bill and would do so using the steps described in section “In-app purchase”. Merchant 300 would then send request to TTS 200 to cancel the pre-payment authorisation.

Alternatively if Customer 100 forgets or elects to not settle their bill, then Merchant 300 can send a payment request to TTS 200, which can then be processed without any interaction from Customer 100, using the pre-payment authorisation.

### Customer Registration and Phone Provisioning

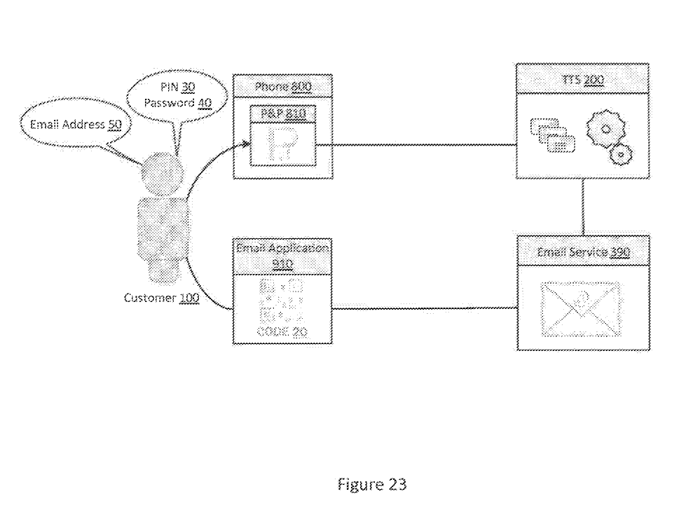

The steps for Customer 100 to provision the P&P 810 application on mobile phone 800 and to register for the P&P service with TTS 200, shown schematically in FIG. 23, are detailed as follows:

Customer 100 installs P&P 810 on Phone 800, launches P&P 810 and is prompted to enter their email address. Customer 100 enters Email Address 50 and selects proceed (Step 24.1).

P&P 810 generates unique DeviceID 265 derived from Phone 800 hardware ID or other unique characteristics and sends Email Address 50 and DeviceID 265 together with provisioning request to TTS 200 (Step 24.2).

TTS 200 sends confirmation to P&P 810 including a message to be displayed to Customer 100 that an email has been sent to them with further instructions (Step 24.3).

TTS 200 generates unique Code 20 and sends Email 90 with registration instructions, Code 20 and QR encoding of it to Email Service 390 addressed to Email Address 50 (Step 24.4).

Email Service 390 sends Email 90 to Email Application 910 (Step 24.5).

Customer 100 reads Email 90 and transfers Code 20 from Email Application 910 to P&P 810 on Phone 800 by scanning QR code or manual entry (Step 24.6).

P&P 810 sends Code 20 and DeviceID 265 to TTS 200, requesting transaction information (Step 24.7).

TTS 200 matches Code 20 to that sent to Email Address 50, creates UserID 255 that is cryptographically derived from Email Address 50, creates unique UserX 256, creates User Profile 250 and stores UserID 255, UserX 256 and DeviceID 265 in User Profile 250 and then sends UserID 255 to P&P 810 (Step 24.8).

P&P 810 stores UserID 255 and prompts Customer 100 to create a strong password and a shorter PIN. Customer 100 enters PIN 30 and Password 40. P&P 810 generates a random Salt 830 and stores it. Salt 830 is then used together with PIN 30 to cryptographically generate Key 45. Similarly PasswordPIN_Hash 120 is cryptographically derived from Password 40 and PIN 30 (Step 24.9).

P&P 810 sends UserID 255, DeviceID 265, Key 45 and PasswordPIN_Hash to TTS 200 (Step 24.10).

TTS 200 creates Wallet 110, stores PasswordPIN_Hash 120 and Email Address 50 in Wallet 110 and then encrypts Wallet 110 using Key 45 producing WalletE 260 associated with DeviceID 265 that is stored in User Profile 250 associated with UserID 255.

TTS 200 sends confirmation to P&P 810 that registration was successful and that further personal information can now be securely registered (Step 24.11).

Customer 100 enters their personal information (for example name, postal address, title, date of birth, gender) in P&P 810 and selects proceed (Step 24.12).

P&P 810 sends the personal information, UserID 255, DeviceID 265 and Key 45 to TTS 200. TTS 200 retrieves User Profile 250 associated with UserID 255 and decrypts WalletE 260 associated with DeviceID 265 using Key 45, stores the personal information in Wallet 110, encrypts Wallet 110 using Key 45 and stores WalletE 260 associated with DeviceID 265 in User Profile 250 (Step 24.13).

Alternatively using the split key method, the additional steps are:

At Step 24.8 TTS 200 generates random Salt 261, stores it in User Profile 250 and sends it to P&P 810.

At Step 24.9 P&P 810 computes KeyB 266a and Key 45 as:

key 45=ĝH(salt, PIN)
where PIN=PIN 30, the secret PIN entered by Customer 100;
salt=Salt 830a, the salt associated with UserID 255a;
keyW=ĝH(salt, PIN, Password)
where PIN=PIN 30, the secret PIN, and Password=Password 40 the secret Password entered by Customer 100;
salt=Salt 261
keyB=keyW XOR key 45
At Step 24.10 P&P 810 sends KeyB 266a to TTS 200.
At Step 24.11 TTS 200 stores KeyB 266a in User Profile 250 associated with DeviceID 265 and computes KeyW 105 as:
keyW=key 45 XOR keyB
TTS 200 encrypts Wallet 110 using KeyW 105 producing WalletE 260 that is stored in User Profile 250 associated with UserID 255.

### Multiple TTS

As a further alternative to the payment and brokered transaction systems described, multiple TTS can be supported. This enables for example enterprises to operate a TTS integrated into their own enterprise IT infrastructure for their own secure business use, which is not accessible to users who are not registered with that TTS.

When Customer 100 registers with TTS 200a to use the P&P service, TTS 200a sends TTS_ID 205a that uniquely identifies TTS 200a, as well as TTS_URL 206a that is the URL used by P&P 810 to communicate with TTS 200a. P&P 810 stores the TTS_URL 206a associated with TTS_ID 205a and the TTS_ID 205a associated with UserID 255a.

To accommodate multiple TTS the TTS_ID 205 is included in Code 20, which then enables P&P 810 to determine the appropriate TTS_URL 206 to use to communicate with the TTS associated with the received TTS_ID 205.

With reference to the steps described in section “Login to online service”, these are the alternative steps for a system that supports multiple TTS:

Online Service 380a sends transaction details and requests Code 20 from TTS 200a (Step 16.2).

TTS 200a generates unique Code 20 that includes TTS_ID 205a and sends it to Online Service 380a (Step 16.3).

Online Service 380a sends updated page with Code 20 and QR encoding of it to Browser 900 (Step 16.4).

Customer 100 transfers Code 20 from Browser 900 to P&P 810 on Phone 800 by scanning QR code or manual entry (Step 16.5).

P&P 810 extracts TTS_ID 205a from Code 20 and retrieves TTS_URL 206a associated with TTS_ID 205a and uses TTS_URL 206a as the URL to send Code 20 and UserID 255 to TTS 200a, requesting transaction information (Step 16.6).

TTS 200a matches Code 20 to that sent to Online Service 380a and sends the corresponding transaction information to P&P 810 (Step 16.7).

### Card Enrolment Using Manual Entry

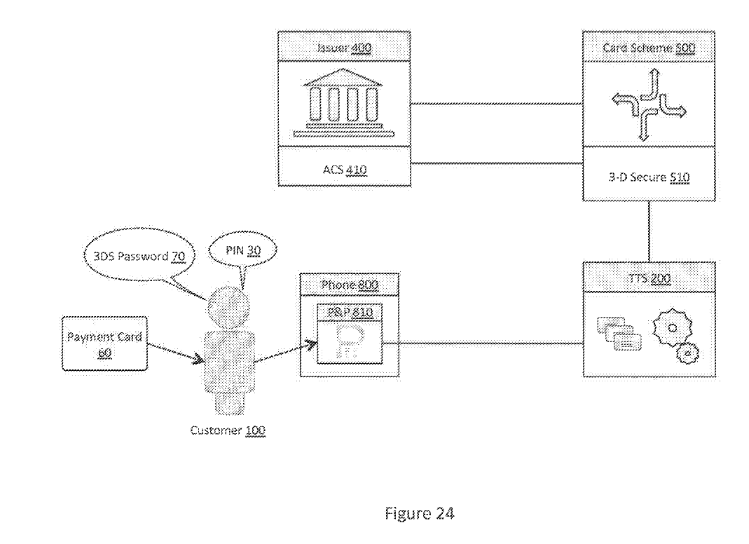

The steps for Customer 100 to manually enroll a payment card 60, shown schematically in FIG. 24, are detailed as follows:

Customer 100 selects option in P&P 810 on Phone 800 to enroll Payment Card 60. Customer 100 enters PIN 30 in response to prompt to enter their PIN and selects proceed (Step 25.1).

P&P 810 sends UserID 255, DeviceID 265, Key 45 and request to enroll a card to TTS 200 (Step 25.2).

TTS 200 authenticates Customer 100 and sends confirmation to P&P 810 (Step 25.3).

P&P 810 confirms PIN accepted and prompts Customer 100 to enter card details. Customer 100 enters the details of Payment Card 60 and selects proceed (Step 25.4).

P&P 810 sends Payment Card 60 details entered by Customer 100, UserID 255, DeviceID 265 and Key 45 to TTS 200 (Step 25.5).

TTS 200 sends a pre-payment authorisation request to PSP 700 using the supplied Payment Card 60 details (Step 25.6).

PSP 700 receives the pre-payment authorisation and sends confirmation to TTS 200 (Step 25.7).

TTS 200 sends card authentication query to 3-D Secure 510 using PAN from Payment Card 60 (Step 25.8).

3-D Secure 510 sends authentication query response to TTS 200 confirming whether 3-D Secure authentication is available for Payment Card 60 or not (Step 25.9).

TTS 200 sends authentication query response and confirmation that card details are correct to P&P 810 (Step 25.10).

P&P 810 displays confirmation that card details are correct and that 3-D Secure authentication is required. If 3DS authentication is not available for Payment Card 60, P&P 810 displays explanation that the card has not yet been registered for 3-D Secure and that the customer should do so first. Customer 100 enters 3DS Password 70 and selects proceed (Step 25.11).

P&P 810 sends 3DS Password 70, UserID 255, DeviceID 265 and Key 45 to TTS 200 (Step 25.12).

TTS 200 authenticates with 3-D Secure 510 and sends card authentication request to 3-D Secure 510 using Payment Card 60 and 3DS Password 70 (Step 25.13).

3-D Secure sends PARes to TTS 200 confirming 3DS Password 70 is correct. TTS 200 retrieves User Profile 250 associated with UserID 255 and decrypts WalletE 260 associated with DeviceID 265 using Key 45, stores the Payment Card 60 details and 3DS Password 70 in Financial Instrument 140 in Wallet 110, encrypts Wallet 110 using Key 45 and stores WalletE 260 associated with DeviceID 265 in User Profile 250 (Step 25.14).

TTS 200 sends confirmation to P&P 810 that 3-D Secure authentication was successful and that Financial Instrument 140 is now available for use (Step 25.15).

As an added security measure, Issuer 400 could require at Step 25.11 that Customer 100 has the physical Payment Card 60 and using a card reader supplied by Issuer 400, enters the PIN for Payment Card 60 on the reader and types the code displayed on the card reader into P&P 810. The code is sent to TTS 200 at Step 25.12 and verified by Issuer 400 at Step 25.13.

### Card Enrolment Using Online Banking

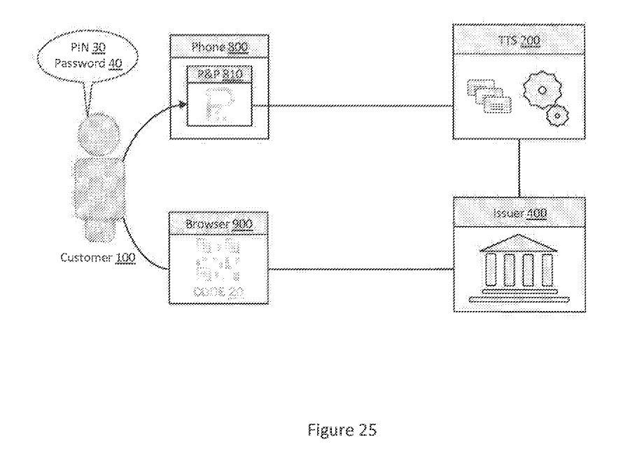

The steps for Customer 100 to automatically enroll a payment card 60 using online banking, shown schematically in FIG. 25, are detailed as follows:

Customer 100 is already signed in to the online banking service provided by Issuer 400.

Customer 100 selects option to enroll a payment card, selects Payment Card 60 and selects ‘P&P Enroll’ button. Browser 900 sends event to Issue 400 (Step 26.1).

Issuer 400 sends transaction details and requests Code 20 from TTS 200 (Step 26.2).

TTS 200 generates unique Code 20 and sends it to Issuer 400 (Step 26.3).

Issuer 400 sends updated page with Code 20 and QR encoding of it to Browser 900 (Step 26.4).

Customer 100 transfers Code 20 from Browser 900 to P&P 810 on Phone 800 by scanning QR code or manual entry (Step 26.5).

P&P 810 sends Code 20 and UserID 255 to TTS 200, requesting transaction information (Step 26.6).

TTS 200 matches Code 20 to that sent to Issuer 400 and sends the corresponding transaction information to P&P 810 (Step 26.7).

P&P 810 displays the transaction information with a prompt to check the details and proceed if correct. Customer 100 checks the displayed details and selects option to proceed. Customer 100 then enters PIN 30 and Password 40 in response to prompt to enter their PIN and Password (Step 26.8).

P&P 810 sends transaction approval, UserID 255, DeviceID 265, Key 45 derived from PIN 30 and PasswordPIN_Hash 120 to TTS 200 (Step 26.9).

TTS 200 decrypts the wallet data, authenticates Customer 100 and sends transaction authorisation to Issuer 400 (Step 26.10).

Issuer 400 sends Payment Card 60 details and associated 3DS Password 70 to TTS 200. TTS 200 retrieves User Profile 250 associated with UserID 255 and decrypts WalletE 260 associated with DeviceID 265 using Key 45, stores the Payment Card 60 details and 3DS Password 70 in Financial Instrument 140 in Wallet 110, encrypts Wallet 110 using Key 45 and stores WalletE 260 associated with DeviceID 265 in User Profile 250 (Step 26.11).

Issuer 400 sends updated page to Browser 900 confirming that passwords were accepted and that Payment Card 60 has been submitted for enrolment (Step 26.12).

TTS 200 sends confirmation to P&P 810 that Financial Instrument 140 is now available for use (Step 26.13).

As an added security measure, Issuer 400 could require at Step 26.1 that Customer 100 has the physical Payment Card 60 and using a card reader supplied by Issuer 400, enters the PIN for Payment Card 60 on the reader and types the code displayed on the card reader into Browser 900, or proof of ownership is established through a verification step using established means configured for that card, e.g. 3-D Secure. A variant of this scenario is to use an ATM to enroll a card. In this case the ATM acts as the card reader, thereby proving ownership of the card.

### Use of Validated Information

Personal Information 130 that is stored in Wallet 110 can optionally be validated by an accredited third party Validation Service 375 that enables Merchant 300, the information requesting party, to either receive a Validity Certificate 75 if requested or confirmation that the Information 130 provided by TTS 200 has been validated by Validation Service 375. Additional information that is derived from personal Information 130, which has been validated, can then in turn be confirmed as being validated. An example is proof of age that is derived from validated date of birth.

All financial instruments are validated when they are enrolled and cannot be used until they have been validated. Certificates of validity are not used for financial instruments because Merchant 300 cannot request to receive any financial instrument information.

Merchant 300 when requesting information fields can, in addition to specifying whether the information field is optional or mandatory, request confirmation that the Information 130 field is validated or not and optionally the associated Validity Certificate 75. Merchant 300 can then decide whether or not to use non-validated Information 130; and for validated Information 130, to optionally verify the information or the credentials of the third party Validation Service 375.

The reason for allowing non-validated information is user convenience. Registration for new users needs to be quick and simple. They can later validate some or all of their personal information to benefit from increased utility. Validation takes more effort and introduces some delay. In addition there could be a charge for using a validation service (provided for example by a bank or notary) that some customers may not wish to pay for.

### Anonymous Proof of Age by Telephone

The method beneficially can be used to securely transact by telephone without disclosing any confidential or personal information over the telephone, providing defense against phishing and eavesdropping as explained by the following example:

With reference to FIG. 8, Customer 100 is required to prove that they are over 21 to proceed with the transaction being conducted by telephone, and proceeds as follows:

Operator 160 instructs Terminal 385 to send an age request to Merchant 300.

Merchant 300 sends a P&P validated age request to TTS 200 and receives Code 20.

Merchant 300 sends Code 20 to Terminal 385 and Operator 160 reads out the code to Customer 100 who enters it manually into P&P 810.

P&P 810 sends Code 20 and UserID 255 to TTS 200, receives the transaction information that is displayed with a prompt to check the details and proceed if correct.

Customer 100 checks the displayed details that include information identifying Merchant 300 and Operator 160, thereby establishing their authenticity and that they are not being phished, and selects option to proceed.

Customer 100 then enters PIN 30 and P&P 810 sends transaction approval, UserID 255, DeviceID 265 and Key 45 derived from PIN 30 to TTS 200.

TTS 200 decrypts the wallet data, authenticates Customer 100 and using the validated date of birth calculates that Customer 100 is over 21, and sends transaction confirmation to Merchant 300.

Operator 160 is now able to proceed with the transaction having received verifiable proof that Customer 100 is over 21. Customer 100 did not have to provide any information over the telephone nor disclose their identity to Merchant 300.

### Information Validation

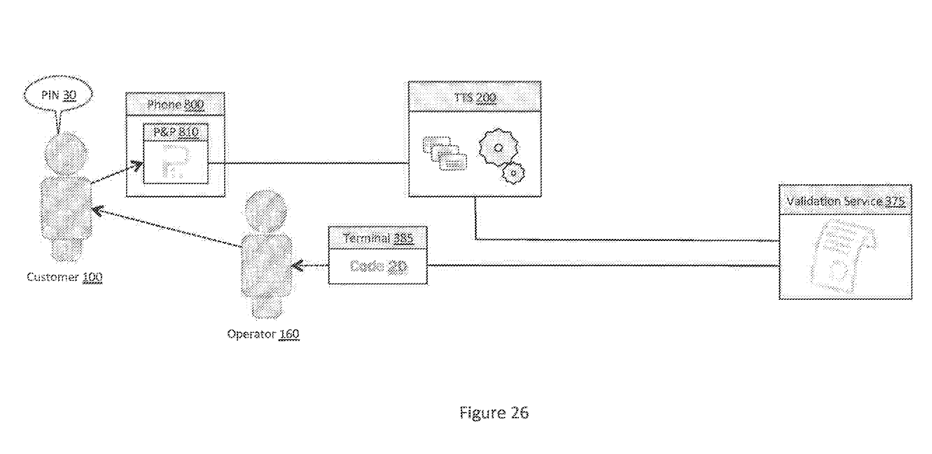

As shown in FIG. 26, the method can be used to securely validate information that in turn can be used for purposes described in section “Use of validated information” above; the detailed steps are as follows:

Customer 100 informs Operator 160 which fields they wish to have validated. Operator 160 enters the request and Terminal 385 sends the request to Validation Service 375 (Step 27.1).

Validation Service 375 sends transaction information including list of information fields and requests Code 20 from TTS 200 (Step 27.2).

TTS 200 generates unique Code 20 and sends it to Validation Service 375 (Step 27.3).

Validation Service 375 sends Code 20 and QR encoding of it to Terminal 385 (Step 27.4).

Customer 100 transfers Code 20 from Terminal 385 to P&P 810 on Phone 800 by scanning QR code or manual entry (Step 27.5).

P&P 810 sends Code 20 and UserID 255 to TTS 200, requesting transaction information (Step 27.6).

TTS 200 matches Code 20 to that sent to Validation Service 375 and sends the corresponding transaction information to P&P 810 (Step 27.7).

P&P 810 displays the transaction information and list of requested information fields with a prompt to check the details and proceed if correct. Customer 100 checks the displayed details and selects option to proceed. Customer 100 then enters PIN 30 in response to prompt to enter PIN (Step 27.8).

P&P 810 sends validation request, list of approved fields for sharing, UserID 255, DeviceID 265 and Key 45 derived from PIN 30 to TTS 200 (Step 27.9).

TTS 200 decrypts the wallet data, authenticates Customer 100, retrieves the list of Information 130 and the associated InfmID 125 from Wallet 110 and sends a validation authorisation and the list of Information 130 and associated InfmID 125 to Validation Service 375 (Step 27.10).

Validation Service 375 sends the list of Information 130 to Terminal 385 (Step 27.11).

Terminal 385 displays the list of Information 130 and Operator 160 verifies that the information is correct and provides confirmation to Terminal 385 (Step 27.12).

Terminal 385 sends the confirmation to Validation Service 375 (Step 27.13).

Validation Service 375 generates a Validation Reference 76 and Validity Certificate 75 for each InfmID 125 and the associated Information 130 and sends it to Terminal 385. Terminal 385 displays the Validation Reference 76 to be made available to Customer 100 (Step 27.14).

Validation Service 375 sends the list of InfmID 125 and associated Validity Certificate 75 to TTS 200 (Step 27.15).

TTS 200 stores the list of Validity Certificate 75 associated with InfmID 125 in Wallet 110, and sends validation confirmation and the list of Validation Reference 76 to P&P 810 (Step 27.16).

The Validity Certificate 75 contains a cryptographic hash (fingerprint) of Information 130 and does not include any of Information 130. The certificate also includes the identity of Validation Service 375 and Validation Reference 76 to enable auditing of the validation.

### Duress PIN

Customer 100 is forced to divulge or enter their PIN under duress. Rather than providing their correct PIN 30, Customer 100 can provide their Duress PIN 35 that they have configured, which then raises an alarm at TTS 200 that can then take appropriate action. Specific contact information DuressE 295 in case of emergency is stored associated with Customer 100.

The following steps are used to setup the duress information and PIN. Customer 100 enters Duress PIN 35 and the duress contact information. Salt 830 is used together with Duress PIN 35 to cryptographically generate KeyD 46 that is used to encrypt DuressE 295 information stored in User Profile 250.

The following steps are used to raise a duress alarm:

Customer 100 enters Duress PIN 35. Salt 830 is used together with Duress PIN 35 to cryptographically generate KeyD 46, which is sent to TTS 200 together with UserID 255. TTS 200 retrieves User Profile 250 associated with UserID 255 and if KeyD 46 is authenticated then an alarm is raised. TTS 200 can optionally send a request to P&P 810 to return the GPS location of Phone 800 to facilitate locating and helping Customer 100. TTS 200 can then block any further requests for transactions for Customer 100 until the alarm has been cleared.

### Multiple User Accounts

As shown in FIGS. 1 and 2, both P&P 810 and TTS 200 support the provisioning of multiple Customer 100 accounts, UserID 255, that are associated with the same or multiple different individuals. This allows for example two different individuals to share the same mobile phone 800, each with their own personal information, financial instruments etc. or for one individual to have one account for personal use and another account for business use.

Customer 100 provides a descriptive name, Greeting 257, for their new account when provisioning P&P 810 that is stored in User Profile 250 associated with UserID 255. P&P 810 displays Greeting 257 to identify to Customer 100 the name of the account that is currently selected for use with the system. Customer 100 can easily switch between accounts by selecting the option in P&P 810 to change accounts and then selecting the account that they then wish to use.

### Geo-Location Data

If available and the user has consented for their location data to be shared with the TTS, then for each transaction the geo-location of the computing device 800 is sent to TTS 200. For example, where the computing device 800 is a mobile phone, GPS location from the phone's operating system can be sent to the TTS 200. Similarly, other geo-location technologies are known for ascertaining the location of a mobile phone or computing device based for example on the phone base station being used by the phone, or the IP address allocated to a computer. This information can be used by the TTS 200 or merchant for fraud detection or other security measures, for example geo-fencing i.e. restricting transactions to be completed within defined geographic areas or in a confirmation message sent to the user following the completion of a brokered transaction.

### Secure Environment

A key objective is for the P&P 810 application to be secure against hostile attackers and malware. The most secure option is to use a dedicated tamper-proof device with a secure operating system to run application P&P 810. This is inconvenient for Customer 100 as they then have to carry an additional device that will also possibly need a further account with a wireless network operator, incurring additional expense.

A solution on a general purpose computing device is to have a secure computing environment or element that can take complete control of the device display and associated input devices, for example touchscreen, keyboard or mouse, and that can disable all interrupts or hooks such that malware cannot execute during the secure user interaction period, nor access memory or other computing resources associated with the display or input devices. A secure element could be implemented using hypervisor technology. The P&P 810 application then runs in the secure element, ensuring that it is safe from malware that may be running on the Phone 800.

Embodiments of the present disclosure have been described with particular reference to the examples illustrated. However, it will be appreciated that variations and modifications may be made to the examples described within the scope of the present disclosure.

1. A method of brokering a transaction between a first party and a second party with a trusted transaction server (TTS), the method comprising:
receiving at the TTS a request for a brokered transaction from the first party, the request being sent over a first communication channel from a first application running on a computing device, the request comprising at least some transaction details;
authenticating the identity of the first party with the TTS;
generating a transaction code for the transaction;
storing the transaction code with at least some transaction details received from the first party at the TTS;
receiving at the TTS a message from the second party, the message being sent over a second communication channel from a second application running on a computing device, the message containing the transaction code,
matching the transaction code received from the second party with the transaction details for that transaction code stored at the TTS,
sending a request for authorization for brokering the transaction from the TTS to the second party including at least some of the details of the transaction for display to the second party,
the TTS authenticating the identity of the second party by way of a secret code received from the second application and receiving authorization by the second party for brokering the transaction,
with the TTS, brokering the transaction with the first party and/or a third party including sending information necessary for authorization of the transaction to the first party and/or third party.

2. The method according to claim 1, comprising creating a profile for the second party including information associated with the second party, wherein the TTS accesses the profile and supplies some or all of the information to the first party and/or third party when brokering the transaction.

3. The method according to claim 2, wherein the profile comprises reserved information which can be accessed by the TTS only once the second party has authenticated, and unreserved information which can be accessed without the second party having authenticated.

4. The method according to claim 3, wherein the reserved information consists of a wallet comprising one or more of:
information relating to the second party, optionally including one or more of the party's title, name, surname, date of birth, postal address, email address, telephone number, gender, marital status;
details of financial instruments held by the second party, such as card numbers, start dates, expiry dates, bank accounts, bank sort code, bank details and associated information needed to use the financial instrument, such as passwords, 3-D Secure information, CVV codes;
details of security information required to use the TTS such as one or more of passwords;
details of loyalty or rewards accounts optionally including account numbers, card numbers and scheme name or identifier; and,
details of online service accounts including an account identifier and optionally a password.

5. The method according to claim 3, wherein said reserved information can be made available by the TTS or used in a transaction only when the brokering of the transaction has been authorized by the second party.

6. The method according to claim 3, wherein the reserved information is stored in encrypted form and can be decrypted using the secret code or a key derived from at least the one or more secret codes.

7. The method according to claim 6, wherein the reserved information is stored in encrypted form and is encrypted and decrypted at the TTS using a key derived from a first random salt stored in the second party profile and two or more secrets;
the key being cryptographically split with the first part being stored in the second party profile and the second part derived from a second random salt stored in the second party computing device and one secret.

8. The method according to claim 1, comprising communicating the transaction code from the first party to the second party optionally over a non secure channel.

9. The method according to claim 1, wherein the transaction code is generated such that it is unique for a predetermined length of time, unique for the first party, and/or unique for the TTS, or any combinations thereof.

10. The method according to claim 1, wherein the transaction code is generated by:
generating the transaction code at the TTS and communicating it to the first party over the first communication channel, or
generating the transaction code at the first party computing device and communicating it to the TTS over the first communication channel.

11. The method according to claim 1, wherein authentication comprises at least one additional factor which is verified by the TTS, including one or any combination of:
the mobile device identity;
the answer to a security question; and,
a password or phrase.

12. The method according to claim 2, wherein the transaction type is the second party signing-in to an account for an online service associated with the first party,
the profile for the second party including a record containing an identifier for the online service and an identifier which identifies the second party's account to the online service,
the method comprising:
wherein the transaction details sent from the first party to the TTS include an identifier for the online service, this being sent to the second party for display;
when authorization for brokering the transaction is received from the second party, the TTS finding the identifier for the account for the second party and for that online service from the second party's profile; and,
sending the account identifier and confirmation that second party has been authenticated so that the user can be signed-in to the online service by the online service.

13. The method according to claim 12, wherein the TTS participates in a challenge-response authentication protocol with the first party using at least one secret from the account identifier to broker the authentication of the second party with the first party.

14. The method according to claim 2, wherein the transaction type is the second party signing-in to an account for an online service associated with the first party,
the profile for the second party including one or more records containing information which identifies the second party's account to the online service,
the method comprising:
wherein the transaction details sent from the first party to the TTS include a request for the identifying records, this being sent to the second party for display;
when authorization for brokering the transaction is received from the second party, the TTS finding the identifying records from the second party's profile; and,
sending said records and confirmation that the second party has been authenticated so that the second party can be signed-in to the online service by the online service.

15. The method according to claim 2, wherein the transaction type is the second party signing-up to an account for an online service associated with the first party, the method comprising:
wherein the transaction details sent from the first party to the TTS include a list of one or more user information fields requested for creating the account, for being sent to the second party for display;
when authorization for brokering the transaction is received from the second party, the TTS finding the user information for the requested fields from the second party's profile and sending the information for the requested fields to the online service;
the online service creating an account and an account identifier for that account and sending the account identifier to the TTS; and,
the TTS storing the account identifier associated with the online service identifier in the second party's profile.

16. The method according to claim 2, wherein the transaction type is the second party registering with an existing account for an online service associated with the first party when signed-in to said account, the method comprising:
wherein the transaction details sent from the first party optionally include a list of one or more user information fields requested for verifying the account, for being sent to the second party for display;
when authorization for brokering the transaction is received from the second party, the TTS finding the user information for the requested fields from the second party's profile and sending the information for the requested fields to the online service;
the online service verifying the requested fields;
the online service optionally authenticating the second party using means configured for that online account;
the online service sending the account identifier for the account to the TTS; and,
the TTS storing the account identifier associated with the online service identifier in the second party's profile.

17. The method according to claim 12, wherein the account identifier consists of one or more of:
a unique account code;
a password;
a cryptographic token; and,
a cryptographic key for the production of digital signatures.

18. The method according to claim 2, wherein the transaction is an authorization of an action requested by the second party on an online service associated with the first party, the method comprising:
wherein the transaction details sent from the first party to the TTS include an identifier for the online service and details for the action being taken, this being sent to the second party for display;
when authorization for brokering the transaction is received from the second party, the TTS sending the authorization for the action being taken to the online service so that the online service can allow the action to be taken.

19. The method according to claim 18, wherein the second party profile includes a record containing an identifier for the online service, an identifier which identifies the user's account to the online service and a cryptographic key associated with said online account, the method comprising:
the TTS finding the cryptographic key associated with the online account and digitally signing details of the action to be taken;
sending the digitally signed details to the online service so that the online service can allow the action to be taken.
